(19) United States
(12) Patent Application Publication
(10) Pub. No.: US 2004/0245507 A1
(43) Pub. Date: Dec. 9, 2004

(54) Conductor composition and method for production thereof

(76) Inventors: Atsushi Nagai, Nagoya-shi (JP); Kazutaka Nakayama, Nagoya-shi (JP)

Correspondence Address: OLIFF & BERRIDGE, PLC, P.O. BOX 19928, ALEXANDRIA, VA, 22320, US

(21) Appl. No.: 10/488,615

(22) PCT Filed: Jul. 25, 2002
(86) PCT No.: PCT/JP02/07530

(30) Foreign Application Priority Data
Sep. 6, 2001 (JP) 2001-269788

(51) Int. Cl. H01C 1/00

(52) U.S. Cl. 252/500

(57) ABSTRACT

The present invention provides a conductor composition that can be formed into a film conductor having a resistance to soldering heat of a sufficient level in practical use without using a large amount of expensive precious metals such as Pd and without performing a Ni plating treatment or other treatments separately. This conductor composition is provided in the form of paste or ink having metal powder as the main component. This metal powder is constituted substantially by particulates of Ag or an Ag based alloy whose surface is coated with an organic metal compound. The organic metal compound is preferably an organic acid metal salt, metal alkoxide or a chelate compound having as a main constituent metal element any one selected from the group consisting of Al, Zr, Ti, Y, Ca, Mg and Zn.

### TECHNICAL FIELD

The present invention relates to conductor compositions prepared in the form of paste or ink used to form a film conductor (in particular, thick film conductor) on a ceramic substrate or the like by a thick-film printing method or the like, and a method for producing the same.

### BACKGROUND ART

Conductor paste compositions (or also referred to as “conductor ink compositions”) are used as a material for forming a film conductor (wiring, electrodes, etc.) in a predetermined pattern in a ceramic wiring substrate or other ceramic electronic components used to construct a hybrid IC, a multi-chip module or the like.

The conductor paste is prepared by dispersing a metal powder that is the main component to form a conductor and various additives (inorganic binder, glass frit, filler, etc.), which is added, if necessary, in a predetermined organic solvent (vehicle). Such a paste is a conductor forming material that is commonly used to form a film conductor having a thickness of 10 to 30 μm (i.e., thick film). More specifically, the conductor paste is applied onto a ceramic substrate or the like by a commonly used method such as screen printing, and then the coating substance (coating film) is fired (fired and attached ) at a suitable temperature. Thus, a film conductor having a predetermined pattern is formed on a ceramic electronic component such as the ceramic substrate.

A typical example of such a conductor paste is one based on silver (Ag) as the metal powder (hereinafter, referred to as “Ag paste”). The Ag powder can be available in a lower cost than those of gold (Au), platinum (Pt), palladium (Pd) or the like, and further has a low electrical resistance. Therefore, the Ag paste is widely used to form film conductors in various electronic components.

Film conductors formed with Ag paste formed only of Ag as the metal powder has a low resistance to soldering heat, that is, resistance to solder leaching. Therefore, high temperatures in attaching various elements to the film conductor by soldering may cause “solder leaching (typically, melting of Ag contained in the film conductor into the solder)”. Significant occurrence of solder leaching is not preferable because the bondability between a circuit formed of the film conductor and the element is deteriorated, which may cause broken lines or other poor conduction.

Therefore, in order to prevent such solder leaching, in other words, improve the resistance to soldering heat, a plating film of nickel (Ni) or copper (Cu) may be formed on the surface of the conductor made of Ag (e.g., Japanese Laid-Open Patent Publication No. 10-163067). When a Ni plating film or the like is formed on a surface of the film conductor, the plating film serves as a barrier so that solder leaching of the Ag based conductor can be prevented.

However, it is not preferable to perform metal plating separately in this manner, because this complicates the production process of the ceramic electronic component such as a ceramic substrate (e.g., multilayer ceramic capacitor). Furthermore, such an additional process of plating can increase the production cost of the electronic component.

As another means for reducing or preventing solder leaching, a conductor paste based on a mixed metal powder of Ag and palladium (Pd) or a mixed metal powder of Ag and platinum (Pt) is used, instead of a paste made only of Ag. The film conductor made of Ag and Pd or Pt formed using such a paste can reduce or prevent solder leaching.

However, so-called “solder wettability (adherence with solder)” of the film conductor made of Ag and Pd or Pt is poorer than that of the conductor made only of Ag. Furthermore, Pd and Pt are more expensive than Ag, which may increase the production cost of the ceramic electronic component.

Therefore, there is a demand for a conductor paste based on Ag that can be formed into a film conductor having improved resistance to soldering heat without using a large amount of such expensive precious metals, or separately performing Ni plating or the like in the field of production of electronic components such as ceramic capacitors.

### DISCLOSURE OF INVENTION

The present invention provides an improved paste-like (ink-like) conductor composition based on Ag. More specifically, it is an object of the present invention to provide an Ag based conductor paste (ink) composition in which the solder wettability and the resistance to soldering heat of sufficient level in practical use are achieved and a method for producing the same. It is another object of the present invention to provide a method for producing a ceramic electronic component using such a conductor composition.

A conductor composition provided by the present invention includes a metal powder substantially constituted by particulates (typically, referred to as particles having a particle size of about 10 μm or less) of Ag or an Ag based alloy whose surfaces are coated with at least one organic metal compound having as a constituent metal element any one selected from the group consisting of aluminum (Al), zirconium (Zr), titanium (Ti), yttrium (Y), calcium (Ca), magnesium (Mg) and zinc (Zn), and an organic medium in which the metal powder is dispersed.

This conductor composition is an organic compound in which particulates of Ag or an Ag based alloy (hereinafter, referred to as “Ag based particulates”) are coated with the organic metal compound of the above-describe type (that is, organic compounds having various metals regardless of whether or not there is a carbon-metal bond, which also applies to the following). Thus, the resistance to soldering heat of a fired product (i.e., film conductor) formed of the Ag based particulates can be significantly improved.

In order words, when the conductor paste (conductor ink) of the present invention is used, a film conductor (typically, a thickness of 1 to 30 μm) provided with solder wettability comparable to conventional Ag pastes and resistance to soldering heat sufficient in practical use in which solder leaching hardly occur can be formed (fired and attached) on a ceramic base material.

It is preferable that the organic metal compound is an organic acid metal salt, metal alkoxide or a chelate compound having as a constituent metal element any one selected from the group consisting of Al, Zr, Ti, Y, Ca, Mg and Zn.

One preferable conductor composition is characterized in which the coating amount (content) of the organic metal compound is an amount corresponding to 0.01 to 2.0 wt % of the total amount of the particulates in terms of the oxide of the metal element constituting the compound (i.e., the weight of the metal oxide (e.g., Al₂O₃ or ZrO₂) obtained when the organic metal compound is fired). According to the conductor composition having this constitution, both the solder wettability and the resistance to soldering heat that are sufficient in practical use can be realized while low resistivity (i.e., sufficient conductivity) equal to that of conventional film conductors formed only of Ag is maintained.

Another preferable conductor composition is characterized in that the average particle size of the Ag based particulates is 2.0 μm or less (e.g., 0.2 to 2.0 μm). According to this conductor composition (paste or ink) containing particulates having such a particle size, a film conductor (thick film) having solder wettability and resistance to soldering heat that are excellent in practical use and reduced occurrence of significant pores that might cause resistance increase or disconnection, and having a dense structure that provides excellent bond strength with the ceramic base material can be formed. For example, a dense film conductor (hereinafter, referred to as “surface film conductor”) can be formed on a wide surface of a multilayer ceramic capacitor.

Alternatively, a film conductor such as so-called terminal electrodes (hereinafter, referred to as “side film conductor”) can be formed on a side face (either face adjacent to a face in which the surface film conductor is formed, which also applied to the following) of such a multilayer ceramic electronic component.

Furthermore, the present invention provides a method for producing a paste-like (ink-like) conductor composition having the above-described metal powder as a main component. This method includes preparing Ag based particulates; coating a surface of the particulates with at least one organic metal compound (herein, the organic metal compound is at least one organic acid metal salt, metal alkoxide or chelate compounds having as a constituent metal element any one selected from the group consisting of Al, Zr, Ti, Y, Ca, Mg and Zn); and dispersing the particulates coated with the organic metal compound in an organic medium.

Furthermore, the present invention provides a method for producing a ceramic electronic component including a ceramic base material in which a film conductor is formed. This method includes applying a paste-like or ink-like conductor composition obtained by dispersing the Ag based particulates whose surfaces are coated with at least one organic acid metal salt, metal alkoxide or chelate compound having any one of the above-described metal elements in an organic medium to a ceramic base material; and firing the applied conductor composition to form a film conductor on the ceramic base material.

In this specification, “ceramic electronic component” is a term referring to general electronic components having a base material (base) made of ceramics. Therefore, hybrid ICs, multichip modules, and ceramic wiring substrates constituting them, or multilayer ceramic capacitors are typical examples of the “ceramic electronic components” defined in this specification.

By this method, a ceramic electronic component provided with a film conductor in which the solder wettability and the resistance to soldering heat that are sufficient in practical use can be realized while low resistivity equal to that of conventional film conductors formed only of Ag is maintained can be produced. The ceramic electronic component obtained by this method has good bonding properties (high bond strength) with other electronic elements or circuits, and thus excellent electronic characteristics and mechanical characteristics,

### BRIEF DESCRIPTION OF DRAWINGS

FIG. 1A is a photograph showing the state after a high temperature firing treatment of the surface of a ceramic substrate to which a conventional Ag paste is applied, and FIG. 1B is a photograph showing the state after a high temperature firing treatment of the surface of a ceramic substrate to which the Ag paste of the present invention is applied.

FIG. 2 is a photograph showing the state of the surface (film conductor) of the ceramic wiring substrate after the ceramic circuit boards of Example 31 and Comparative Examples A and B provided with a film conductor are immersed in a melted solder.

FIG. 3 is a graph showing the amount of coated organic metal salt and/or the firing temperature and the firing shrinkage ratio in one test example.

FIG. 4 is a graph showing the type and the addition amount of inorganic oxide powder and the bond strength (tensile strength) in one test example.

### BEST MODE FOR CARRYING OUT THE INVENTION

Hereinafter, preferable embodiments of the present invention will be described. One typical example of preferable conductor compositions of the present invention is a conductor paste (including compositions in the form of ink, which also applies to the following) characterized by comprising the above-described metal powders as the main components, and there is no particular limitations regarding the type or the composition of other secondary components, as long as the above-described object can be achieved.

The metal powder of the present invention is constituted substantially by a powder comprising Ag based particulates substantially constituted by Ag or an Ag based alloy (e.g., Ag—Au alloys, Ag—Pd alloys) and an organic metal compound with which the surface thereof is coated. As such an Ag based particulates, Ag alone or an Ag alloy having a specific resistance value (two terminal method) of about 1×10⁻³ Ω·cm or less (preferably 1.8 to 5.0×10⁻⁶ Ω·cm, for example, 1.9 to 3.0×10⁻⁶ Ω·cm) is preferable to provide conductivity. Ag based particulates having an average particle size (typically, a measurement value of a particle diameter based on a light-scattering technique) of 2.0 μm or less (preferably 0.3 to 1.0 μm) are preferable to form a fired film having a dense structure, although not limited thereto. Ag based particulates having a comparatively small average particle size and a comparatively narrow grain size distribution that contains substantially no particles having a particle size of 10 μm or more (particularly preferably, a particle size of 5 μm or more) is particularly preferable.

When a paste for surface film conductor formation and a paste for side film conductor formation are distinguished and produced separately, it is preferable that the particle size of the Ag based particulate contained in the paste for side film conductor formation is smaller than that of the Ag based particulate contained in the paste for surface film conductor formation, although it is not limited thereto. For example, the average particle size of the Ag based particulate contained in a conductor paste for forming the paste for a side film conductor (thick film) of a multilayer ceramic circuit substrate to be mounted on a small electronic device (e.g., a low temperature sintering type chip antenna module provided with a mobile telephone device) is preferably less than 0.5 μm (typically 0.3 μm to 0.5 μm). When such a paste containing the Ag based particulate having such a particle size is used, a surface conductor and a side conductor that are dense and have a lower resistance than that of regular surface conductors and side conductors can be formed. Furthermore, a side film conductor (terminal electrodes or the like) that is denser and has a lower resistance than a surface film conductor can be formed. On the other hand, the average particle size of the Ag based particulate contained in a conductor paste for forming a surface film conductor and/or an inner film conductor (which refers to a film conductor that is buried inside when several ceramic sheets are laminated, which also applied to the following) of a chip antenna module as described above is preferably 0.5 μm or more (typically 0.5 μm to 2.0 μm). When such a conductor paste containing the Ag based particulate having such a particle size is used, a surface film conductor and/or an internal film conductor in which excessive sintering shrinkage is suppressed can be formed.

The Ag based particulate itself can be produced by a conventionally known method, and requires no special producing means. For example, Ag based particulates produced by well-known techniques such as reduction/precipitation, a gas phase reaction method, and gas reduction can be preferably used.

Next, organic metal compounds with which the surface of the Ag based particulate is coated will be described. There is no particular limitation regarding the organic metal compound used to coat the Ag based particulate, as long as eventually (after firing), it can form a coating film (that is, an attachment for coating the surface) of a metal (including a metal oxide or a reduced substance thereof) that can achieve the object of the present invention on the surface of the Ag based particulate. However, organic acid metal salts, metal alkoxide or chelate compounds comprising as a constituent metal element any one selected from the group consisting of Al, Zr, Ti, Y, Ca, Mg and Zn can be used preferably.

Preferable examples of metal alkoxide includes titanium (IV) alkoxide such as tetrapropoxytitanium (Ti(OC₃H₇)₄), aluminum alkoxide such as aluminum ethoxide (Al(OC₂H₅)₃), aluminum t-butoxide (Al(OC(CH₃)₃)₃), acetoalkoxy aluminum diisopropylate, acetoalkoxy aluminum ethyl acetoacetate, and acetoalkoxy aluminum acetyl acetonate, zirconium alkoxide such as zirconium ethoxide, and zirconium butoxide, and various polynuclear alcoholate complexes having Zn, Mg, Ca or the like as the central metal atom (or ion). Preferable examples of chelate compounds include ethylene diamine (en) complexes, ethylene diamine tetraacetate (edta) complexes having Zn, Mg, Ca or the like as the central metal atom (or ion). Alternatively, so-called chelate resins in which a chelate is formed with metal (ion) such as Ti, Zn, Mg or the like are also preferable as the organic metal compounds (chelate compounds) of the present invention.

Alternatively, in another embodiment of the present invention, instead of the above-described organic metal compound, various oxide sols (typically alumina sol, zirconia sol or the like) can be used to coat the Ag based particulates of the present invention. In other words, the conductor paste in this case contains the Ag based particulates that is previously coated with a metal compound (oxide) such as alumina, zirconium or the like as the main component.

Other preferable examples of the organic metal compounds used to coat the Ag based particulates of the present invention include organic acid metal salts having as a constituent metal element any one selected from the group consisting of Al, Zr, Ti, Y, Ca, Mg and Zn. In particular, organic acid metal salts having Al or Zr as the main constituent metal element are preferable.

Furthermore, the inventors of the present invention found that an organic acid metal salt of a certain type preferably used when a precious metal powder that can be used at high temperatures and has a different problem to be solved and a different object from those of the present invention (i.e., precious metal powder that is sintered at a high temperature: Japanese Laid-Open Patent Publication No. 8-7644) is produced is preferable as the organic metal compound of the present invention. More specifically, organic acid metal salts that are preferable as an organic metal compound used to coat the Ag based particulates of the present invention are carboxylic acid salts having the above-listed elements as the main constituent metal element. For example, compounds of Al, Ca, Ti, Y or Zr and an organic acid such as various fatty acids (e.g., naphthenic acid, octyl acid, ethyl hexane acid), abietic acid, naphthoic acid or the like can be used. Particularly preferable organic acid metal salts are compounds of Al or Zr and a carboxylic acid (in particular fatty acids).

A fired product of the Ag based particulates coated with an organic acid metal salt having such a composition has a particularly high resistance to soldering heat and high bond strength. Consequently, the conductor paste of the present invention allows a film conductor having resistance to soldering heat and bond strength of sufficient level in practical use to be formed on a ceramic base material, even if inorganic additives described later are not added. Therefore, when the conductor paste of the present invention is used, a film conductor (surface film conductor, side film conductor, inner film conductor, etc.) having resistance to soldering heat or bond strength that is sufficient in practical use can be formed on the ceramic base material without using a large amount of expensive precious metals such as Pd and without performing a complicated plating treatment.

Next, a method for coating the surface of the Ag based particulates with the organic metal compound, that is, a method for producing a metal powder coated with a predetermined organic metal compound will be described.

There is no particular limitation regarding the coating method, as long as, the surface of the Ag based particulates, on which the metal powder to be used is based, is coated with the organic metal compound substantially uniformly and evenly. Therefore, conventionally used methods for coating metal particles with an organic substance can be used as they are. For example, a desired organic metal compound is dissolved or dispersed in a suitable organic solvent such as toluene, xylene, or other various alcohols. Then, the Ag based particulates are added to the obtained solution or dispersion (sol) and dispersed and suspended therein. This suspension is left undisturbed or stirred for a predetermined time so that the surface of the Ag based particulate in the suspension can be coated with the desired organic metal compound. In this case, it is preferable that the metal powder is coated with the desired organic metal compound such that the coating amount of the organic metal compound becomes an amount corresponding to 0.01 to 2.0 wt % (typically 0.01 to 1.0 wt %, for example, 0.01 to 0.1 wt %) of the total amount of the Ag based particulates in terms of the oxide, although it is not limited thereto. When the coating amount is smaller than an amount corresponding to 0.01 wt % of the Ag based particulates in terms of the oxide, the coating effect is too small, so that the object of the present invention is hardly achieved. On the other hand, when the coating amount is excessively larger than an amount corresponding to 2.0 to 3.0 wt % of the Ag based particulates in terms of the oxide, various functions inherent in the Ag based metal powder such as electrical properties may be impaired, so that these amounts are not preferable.

In particular, in the paste for surface film conductor formation, it is preferable that the coating amount is an amount corresponding to 0.025 to 2.0 wt % of the Ag based particulates in terms of the oxide. When the coating substance after firing is alumina, that is, the Ag based particulates are coated with an organic metal compound such as an organic acid metal salt, metal alkoxide, or chelate compounds having Al as a constituent element or alumina (aluminum oxide) itself, it is particularly preferable that the coating amount is an amount corresponding to 0.1 to 2.0 wt % (e.g., 0.2 to 1.0 wt %) of the Ag based particulates in terms of the oxide. In the case of the paste for surface film conductor formation and when the coating substance after firing is zirconia, that is, the Ag based particulates are coated with an organic metal compound such as an organic acid metal salt, metal alkoxide, or chelate compounds having Zr as a constituent element or zirconia (zirconium oxide) itself, it is particularly preferable that the coating amount is an amount corresponding to 0.025 to 1.0 wt % (e.g., 0.025 to 0.5 wt %) of the Ag based particulates in terms of the oxide.

With the conductor paste in such a coating amount, excessive shrinkage hardly occurs during firing, and the difference in the firing shrinkage ratio between the ceramic base material (alumina, zirconia or the like) and the film conductor is prevented from occurring. Therefore, a ceramic electronic component having excellent bond characteristics without significant structural defects such as peeling or cracks can be produced. Such a conductor paste also can be used preferably for inner film conductor formation.

For the paste for side film conductor formation, it is preferable that the coating amount is an amount corresponding to 0.01 to 1.0 wt % of the Ag based particulates in terms of the oxide, although it is not limited thereto. When the coating substance after firing is alumina, that is, the Ag based particulates are coated with an organic metal compound such as an organic acid metal salt, metal alkoxide, or chelate compounds having Al as a constituent element or alumina (aluminum oxide) itself, it is particularly preferable that the coating amount is an amount corresponding to 0.01 to 1.0 wt % (e.g., 0.0125 to 0.1 wt %) of the Ag based particulate in terms of the oxide. In the case of the paste for side film conductor formation and when the coating substance after firing is zirconia, that is, the Ag based particulates are coated with an organic metal compound such as an organic acid metal salt, metal alkoxide, or chelate compounds having Zr as a constituent element or zirconia (zirconium oxide) itself, it is particularly preferable that the coating amount is an amount corresponding to 0.025 to 1.0 wt % (e.g., 0.025 to 0.5 wt %) of the Ag based particulates in terms of the oxide.

Then, preferable substances for the secondary components to be contained in the conductor paste will be described.

A secondary component of the conductor paste can be an organic medium (vehicle) in which the above-described metal powder is dispersed. In practicing the present invention, such an organic vehicle can be any vehicle, as long as the metal powder can be dispersed, and any vehicle used for conventional conductor pastes can be used without any limitations. For example, organic solvents having a high boiling point, such as cellulose polymer such as ethyl cellulose, ethylene glycol and diethylene glycol derivatives, toluene, xylene, mineral spirit, butyl carbitol, and terpineol can be used.

In the conductor paste, various inorganic additives can be contained as secondary components, as long as the conductivity (low resistivity), solder wettability, resistance to soldering heat, bond strength that are inherent in the paste are not significantly impaired. For example, as such an inorganic additive, glass powder, inorganic oxide powder, various fillers or the like can be used. In particular, it is preferable to add a slight amount of glass powder and/or an inorganic oxide.

More specifically, the glass powder can be an inorganic component (inorganic binding material) that contributes to stable firing and firm attachment of the paste component attached onto the ceramic base material (i.e., improvement of the bond strength). In particular, oxide glass powder is preferable. It is preferable that an oxide glass powder having a softening point of about 800° C. or less in terms of the relationship with the firing temperature, which will be described later. As such a glass powder, lead-based, zinc-based and borosilicate-based glass can be used. Typically, it is suitable to use at least one glass powder selected from the group consisting of the following oxide glass having oxide as the main component, that is, PbO—SiO₂—B₂O₃ glass, PbO—SiO₂—B₂O₃—Al₂O₃ glass, ZnO—SiO₂ glass, ZnO—B₂O₃—SiO₂ glass, Bi₂O₃—SiO₂ glass and Bi₂O₃—B₂O₃—SiO₂ glass. It is preferable that a glass powder to be used has a specific surface area of about 0.5 to 50 m²/g, and a powder having an average particle size (typically a value obtained by measurement according to a light scattering technique or the BET method) of 2 μm or less (in particular, about 1 μm or less) is particularly preferable.

The inorganic oxide can contribute to improvement of the bond strength between the ceramic base material and the film conductor. Furthermore, the inorganic oxide powder can be an inorganic component that prevents excessive shrinkage stress from occurring during firing of the film conductor formed of the conductor paste and contributes to keeping the precision and the mechanical strength of a ceramic electronic component to be produced at a high level in practical use. As such inorganic oxides, metal oxides such as copper oxide, lead oxide, bismuth oxide, manganese oxide, cobalt oxide, magnesium oxide, tantalum oxide, niobium oxide, or tungsten oxide are particularly preferable. Among these, copper oxide, lead oxide and bismuth oxide are particularly preferable. In particular, bismuth oxide is particularly preferable, because it can accelerate sintering of the Ag based metal powder and can improve the wettability between Ag and the ceramic base material (alumina or the like). Copper oxide can improve the adherence to the substrate.

As the metal oxide (inorganic oxide) to be used, a powder having an average particle size (typically a value obtained by measurement according to a light scattering technique or the BET method) of 5 μm or less (e.g., 0.01 to 5 μm) is preferable for optimization of the filling ratio and the dispersibility of the paste. A powder having an average particle size of 1 μm or less (e.g., 0.01 to 1 μm) is particularly preferable.

Regarding the specific surface area (value obtained according to the BET method), a powder having a specific surface area of at least 0.5 m²/g is preferable, and a powder having a specific surface area of 1.0 m²/g or more is particularly preferable (typically 1.0 to 2.0 m²/g, particularly preferably 2.0 to 100 m²/g).

In the conductor paste, various organic additives can be contained as secondary components, as long as the conductivity (low resistivity), the solder wettability, the resistance to soldering heat, the bond strength and the like that are inherent in the paste are not significantly impaired. For example, as such an organic additive, various organic binders, various coupling agents such as silicon-based, titanate-based and aluminum-based coupling agents for the purpose of improving the adherence to the ceramic base material or the like can be used.

As the organic binders, for example, organic binders based on acrylic resins, epoxy resins, phenol resins, alkyd resins, cellulose polymers, polyvinyl alcohol or the like can be used. Those that can provide a good viscosity and an ability of forming a coating film (an attached film to the base material) to the conductor paste are preferable. When it is desired to provide photocuring properties (photosensitivity) to the conductor paste, various photopolymerizable compounds and photopolymerization initiator may be added as appropriate.

Other than above, if necessary, a surfactant, an antifoamer, a plasticizer, a thickener, an antioxidant, a dispersing agent, a polymerization inhibitor or the like can be added to the conductor paste, as appropriate. These additives can be any additive, as long as it can be used to prepare a conventional conductor paste, and will not be described in detail.

Next, preparation of the conductor paste will be described. The conductor paste of the present invention typically can be prepared easily by mixing the metal powder and an organic medium (vehicle), as conventional conductor pastes. In this case, if necessary, the above-described additives can be added and mixed. For example, the metal powder and various additives are directly mixed in a predetermined mixing ratio together with an organic vehicle and kneaded, using a three-roll mill or other kneading machines.

It is preferable that the materials are kneaded such that the content ratio of the metal powder that is the main component is 60 to 95 wt % of the entire paste, particularly preferably 70 to 90 wt %, although the present invention is not thereto. For the paste for surface film conductor formation, it is preferable that the materials are kneaded such that this content ratio is 60 to 80 wt % (more preferably 65 to 75 wt %). For the Ag paste for side film conductor formation, it is preferable that the materials are kneaded such that this content ratio is 75 to 95 wt % (more preferably 80 to 90 wt %).

The amount of the organic vehicle added to be used for paste preparation is preferably about 1 to 40 wt %, and particularly preferably 1 to 20 wt % of the entire paste.

When adding the glass powder as described above as an inorganic additive, it is preferable to add it in an amount of about 0.5 wt % or less (e.g., 0.05 to 0.5 wt %), more preferably 0.25 wt % or less (e.g., 0.05 to 0.25 wt %) of the weight of the metal powder. With this small amount, the bond strength of the fired product (film conductor) obtained from the paste with respect to the ceramic base material can be improved, substantially without impairing good conductivity and solder wettability of the conductor paste.

On the other hand, when adding the metal oxide as described above as the inorganic oxide powder, it is preferable to add it in an amount of about 5.0 wt % or less (e.g., 0.001 to 5.0 wt %), more preferably 2.0 wt % or less (e.g., 0.005 to 2.0 wt %), even more preferably 1.0 wt % or less (e.g., 0.005 to 1.0 wt %), and most preferably 0.50 wt % or less (e.g., 0.005 to 0.5 wt %), of the weight of the metal powder. With this small amount, the bond strength of the fired product (film conductor) obtained from the paste of the present invention with respect to the ceramic base material can be improved, and the firing shrinkage can be suppressed, substantially without impairing good conductivity and solder wettability of the conductor paste.

The improvement of the bond strength matters especially to the side film conductor (terminal electrodes or the like). Therefore, when producing a ceramic electronic component, using an oxide ceramic material such as alumina for the ceramic base material and with the paste for surface film conductor formation and the paste for side film conductor formation, it is preferable that the paste for side film conductor formation contains an inorganic oxide powder as a secondary component in a comparatively high content ratio. On the other hand, the paste for surface film conductor formation does not necessarily contain such an inorganic oxide powder, and even if an inorganic oxide powder is contained for the purpose of improving the bond strength, the content ratio may be lower than that of the inorganic oxide powder in the paste for side film conductor formation. For example, when the paste for side film conductor formation contains an inorganic oxide powder such as bismuth oxide or copper oxide, it is preferable that the content ratio is 0.001 to 5.0 wt %, more preferably 0.005 to 2.0 wt %, of the Ag based particulates. On the other hand, it is preferable that the Ag paste for surface film conductor formation contains substantially no inorganic oxide powder or that the content ratio thereof is less than 0.01 wt % of the Ag based metal powder. In particular, containing a comparatively large amount of an oxide glass powder may cause the conductor resistance to increase.

It should be noted that the above-described ranges of the values of the content ratio, the mixing ratio and the like of each component should not be strictly construed, but can depart from the ranges more or less, as long as the object of the present invention can be achieved.

Next, a preferable example in which a film conductor is formed with the conductor paste of the present invention will be described. The conductor paste of the present invention can be handled in the same manner as the conductor paste conventionally used to form a film conductor such as wiring or electrodes on a ceramic base material (substrate), and conventionally known methods can be used without any particular limitation. Typically, the conductor paste is applied onto a ceramic base material (substrate) by screen printing or dispenser coating or the like in a desired shape and thickness. Then, preferably after being dried, the applied paste component is fired (for attachment) and cured by being heated in a heater under suitable heating conditions (typically, the maximum firing temperature is about 500 to 960° C., preferably the temperature range that does not exceed the melting point of Ag, for example, 700 to 960° C., particularly 800 to 900° C.) for a predetermined time. This series of operations provides a ceramic electronic component (e.g., ceramic circuit boards for hybrid IC or multichip module construction) in which desired film conductors (wiring, electrodes, etc.) are formed. Thus, by using this ceramic electronic component as an assembling material and applying a conventionally known construction method, an even more advanced ceramic electronic component (hybrid ICs, multichip modules) can be obtained. Such a construction method itself is not a feature of the present invention, so that it will not be described in detail herein.

Although it is not intended to limit the use, the conductor paste of the present invention can form a film conductor having more excellent resistance to soldering heat and bond strength than those of conventional pastes. Therefore, the conductor paste of the present invention can be preferably used to form not only a conductor having a thickness of about 10 to 30 μm, but also a conductor having a comparatively small thickness of 10 μm or less (e.g., 1 to 10 μm, typically, 5 to 10 μm).

Hereinafter, some examples of the present invention will be described, but it is not intended to limit the present invention to these examples.

### EXAMPLE 1

### Preparation of Conductor Paste (1)

In this example, as the base of the metal powder, an approximately spherical Ag powder having an average particle size of 0.8 to 1.0 μm that was prepared by a commonly used wet process was used. However, as shown as 0.8>>1.0 in the tables below, the particle size distribution is such that particles having a particle size of about 0.8 μm are more than particles having a particle size of about 1.0 μm. On the other hand, as the organic metal compound, aluminum alkoxide (acetoalkoxy aluminum diisopropylate in this example) was used.

Then, the aluminum alkoxide was added to a suitable organic solvent (methanol in this example) and thus a coating solution having a concentration of 5 to 100 g/l was prepared. Then, the Ag powder was suspended in a suitable amount in the solution, and was kept suspended for 1 to 3 hours while being stirred as appropriate. Thereafter, the Ag powder was collected, and dried by ventilation at 60 to 110° C.

By the process described above, Ag powders (hereinafter, referred to as “Al-coated Ag powder”) whose surfaces were coated substantially uniformly with aluminum alkoxide in an amount corresponding to about 0.0125 wt % of the Ag powder in terms of the aluminum oxide (Al₂O₃) were obtained.

Next, materials were weighed such that the final paste concentration (weight ratio) was 87 wt % for the Al-coated Ag powder and the remaining for a solvent (terpineol) and were kneaded with a three-roll mill. Thus, a conductor paste was obtained.

### EXAMPLE 2

### Preparation of Conductor Paste (2)

An Ag powder whose surface was coated substantially uniform with aluminum alkoxide in an amount corresponding to about 0.025 wt % of the Ag powder in terms of aluminum oxide (Al₂O₃) was obtained by adjusting the concentration of the aluminum alkoxide in the coating solution and, if necessary, the suspension time of the Ag powder, as appropriate. Then, a conductor paste was prepared in the same process as in Example 1, using such an Al-coated Ag powder. That is to say, the conductor paste of this example is different from the conductor paste of Example 1 only in the coating amount of aluminum alkoxide.

### EXAMPLE 3

### Preparation of Conductor Paste (3)

An Ag powder whose surface was coated substantially uniform with aluminum alkoxide in an amount corresponding to 0.05 wt % of the Ag powder in terms of aluminum oxide (Al₂O₃) was obtained by adjusting the concentration of the aluminum alkoxide in the coating solution and, if necessary, the suspension time of the Ag powder, as appropriate. Then, a conductor paste was prepared in the same process as in Example 1, using such an Al-coated Ag powder. That is to say, the conductor paste of this example is different from the conductor paste of Examples 1 and 2 only in the coating amount of aluminum alkoxide.

### EXAMPLE 4

### Preparation of Conductor Paste (4)

In this example, as the base of the metal powder, an approximately spherical Ag powder having an average particle size of 0.8 to 1.0 μm was used. However, the powder having a particle size distribution in which particles having a particle size of about 1.0 μm were more than particles having a particle size of about 0.8 μm, as shown as 0.8<<1.0 in the tables below, was used. A conductor paste was prepared with the same materials except the Ag powder in the same process as in Example 1. That is to say, the conductor paste of this example is different from the conductor paste of Example 1 only in the Al powder (particle size distribution).

### EXAMPLE 5

### Preparation of Conductor Paste (5)

A conductor paste was prepared with the same materials in the same process as in Example 4, except that the Ag powder whose surface was coated substantially uniform with aluminum alkoxide in an amount corresponding to 0.025 wt % of the Ag powder in terms of aluminum oxide (Al₂O₃) was obtained by adjusting the concentration of the aluminum alkoxide in the coating solution and, if necessary, the suspension time of the Ag powder, as appropriate. That is to say, the conductor paste of this example is different from the conductor paste of Example 4 only in the coating amount of aluminum alkoxide.

### EXAMPLE 6

### Preparation of Conductor Paste (6)

A conductor paste was prepared with the same materials in the same process as in Example 4, except that the Ag powder whose surface was coated substantially uniform with aluminum alkoxide in an amount corresponding to 0.05 wt % of the Ag powder in terms of aluminum oxide (Al₂O₃) was obtained by adjusting the concentration of the aluminum alkoxide in the coating solution and, if necessary, the suspension time of the Ag powder, as appropriate. That is to say, the conductor paste of this example is different from the conductor paste of Examples 4 and 5 only in the coating amount of aluminum alkoxide.

### EXAMPLE 7

### Preparation of Conductor Paste (7)

In this example, as the base of the metal powder, an Ag powder used in Examples 4 to 6 was used. On the other hand, as the organic metal compound, zirconium alkoxide (zirconium butoxide in this example) was used.

Then, the zirconium alkoxide was added to a suitable organic solvent (methanol in this example) and thus a coating solution having a concentration of 5 to 100 g/l was prepared. Then, the Ag powder was suspended in a suitable amount in the solution, and was kept suspended for 1 to 3 hours while being stirred as appropriate. Thereafter, the Ag powder was collected, and dried by ventilation at 60 to 100° C.

By the process described above, Ag powders (hereinafter, referred to as “Zr-coated Ag powder”) whose surfaces were coated substantially uniformly with zirconium alkoxide in an amount of about 0.1 wt % of the Ag powder in terms of the zirconium oxide (ZrO₂) were obtained.

Next, a conductor paste was prepared using the Zr-coated Ag powder obtained above. More specifically, materials were weighed such that the final paste concentration (weight ratio) was 87 wt % for the Zr-coated Ag powder and the remaining for a solvent (terpineol) and were kneaded with a three-roll mill. Thus, a conductor paste was obtained.

### EXAMPLE 8

### Preparation of Conductor Paste (8)

In this example, a conductor paste containing zinc glass (ZnO—B₂O₃—SiO₂ glass, average particle size: 1 to 2 μm, softening point: 780° C.) as an inorganic additive was prepared.

More specifically, the Al-coated Ag powder obtained in Example 3 (coating amount: 0.050 wt % (in terms of Al₂O₃)) and a zinc glass powder (glass frit having a specific surface area of 1 to 2 m²/g) were used, and these materials were weighed such that the final paste concentration (weight ratio) was 87 wt % for the Al-coated Ag powder and the remaining for a solvent (terpineol), and further the zinc glass powder was added thereto in an amount corresponding to 0.5 wt % of the Ag powder, followed by kneading with a three-roll mill. Thus, a conductor paste was obtained.

### EXAMPLE 9

### Preparation of Conductor Paste (9)

In this example, a paste containing lead glass (PbO—SiO₂—B₂O₃ glass, average particle size: 1 to 2 μm, softening point:. 700° C.) as an inorganic additive was prepared.

More specifically, the Al-coated Ag powder obtained in Example 3 and a lead glass powder (glass frit having a specific surface area of 1 to 2 m²/g) were used, and these materials were weighed such that the final paste concentration (weight ratio) was 87 wt % for the Al-coated Ag powder and the remaining for a solvent (terpineol), and further the lead glass powder was added thereto in an amount corresponding to 0.25 wt % of the Ag powder, followed by kneading with a three-roll mill. Thus, a conductor paste was obtained.

### EXAMPLE 10

### Preparation of Conductor Paste (10)

A conductor paste was prepared by performing the same process as in Example 9, except the amount of the lead glass powder added was an amount corresponding to 0.5 wt % of the total amount of the Ag powder.

### EXAMPLE 11

### Preparation of Conductor Paste (11)

A conductor paste was prepared by performing the same process as in Example 9, except the amount of the lead glass powder added was an amount corresponding to 1.0 wt % of the total amount of the Ag powder.

### EXAMPLE 12

### Preparation of Conductor Paste (12)

In this example, a paste containing borosilicate glass (Bi₂O₃ —B₂O₃ —SiO₂ glass, average particle size: 1 to 2 μm, softening point: 725° C.) as an inorganic additive was prepared.

More specifically, the Al-coated Ag powder obtained in Example 3 and a borosilicate glass powder (glass frit having a specific surface area of 1 to 2 m²/g) were used, and these materials were weighed such that the final paste concentration (weight ratio) was 87 wt % for the Al-coated Ag powder and the remaining for a solvent (terpineol), and further the borosilicate glass powder was added thereto in an amount corresponding to 0.5 wt % of the total amount of the Ag powder, followed by kneading with a three-roll mill. Thus, a conductor paste was obtained.

### EXAMPLE 13

### Preparation of Conductor Paste (13)

In this example, a paste containing a copper oxide (Cu₂O) powder as an inorganic additive was prepared. More specifically, the Al-coated Ag powder obtained in Example 3 and a copper oxide powder (average particle size: 1 to 5 μm, specific surface area: 0.5 to 1.5 m²/g) were used, and these materials were weighed such that the final paste concentration (weight ratio) was 87 wt % for the Al-coated Ag powder and the remaining for a solvent (terpineol), and further the copper oxide powder was added thereto in an amount corresponding to 0.25 wt % of the total amount of the Ag powder, followed by kneading with a three-roll mill. Thus, a conductor paste was obtained.

### EXAMPLE 14

### Preparation of Conductor Paste (14)

A conductor paste was prepared by performing the same process as in Example 13, except the amount of the cupper oxide powder added was an amount corresponding to 0.5 wt % of the total amount of the Ag powder.

### EXAMPLE 15

### Preparation of Conductor Paste (15)

A conductor paste was prepared by performing the same process as in Example 13, except the amount of the cupper oxide powder added was an amount corresponding to 1.0 wt % of the total amount of the Ag powder.

### EXAMPLE 16

### Preparation of Conductor Paste (16)

In this example, a paste containing a lead oxide (Pb₃O₄) powder as an inorganic additive was prepared. More specifically, the Al-coated Ag powder obtained in Example 3 and a lead oxide powder (average particle size: 1 to 5 μm, a specific surface area of 0.5 to 1.5 m²/g) were used, and these materials were weighed such that the final paste concentration (weight ratio) was 87 wt % for the Al-coated Ag powder and the remaining for a solvent (terpineol), and further the lead oxide powder was added thereto in an amount corresponding to 0.25 wt % of the total amount of the Ag powder, followed by kneading with a three-roll mill. Thus, a conductor paste was obtained.

### EXAMPLE 17

### Preparation of Conductor Paste (17)

A conductor paste was prepared by performing the same process as in Example 16, except the amount of the lead oxide powder added was an amount corresponding to 0.5 wt % of the total amount of the Ag powder.

### EXAMPLE 18

### Preparation of Conductor Paste (18)

A conductor paste was prepared by performing the same process as in Example 16, except the amount of the lead oxide powder added was an amount corresponding to 1.0 wt % of the total amount of the Ag powder.

### EXAMPLE 19

### Preparation of Conductor Paste (19)

In this example, a paste containing a bismuth oxide (Bi₂O₃) powder as an inorganic additive was prepared. More specifically, the Al-coated Ag powder obtained in Example 3 and a bismuth oxide powder (average particle size: 1 to 10 μm, a specific surface area of 0.5 to 2.0 m²/g) were used, and these materials were weighed such that the final paste concentration (weight ratio) was 87 wt % for the Al-coated Ag powder and the remaining for a solvent (terpineol), and further the bismuth oxide powder was added thereto in an amount corresponding to 0.25 wt % of the total amount of the Ag powder, followed by kneading with a three-roll mill. Thus, a conductor paste was obtained.

### EXAMPLE 20

### Preparation of Conductor Paste (20)

A conductor paste was prepared by performing the same process as in Example 19, except the amount of the bismuth oxide powder added was an amount corresponding to 0.5 wt % of the total amount of the Ag powder.

### EXAMPLE 21

### Preparation of Conductor Paste (21)

A conductor paste was prepared by performing the same process as in Example 19, except the amount of the bismuth oxide powder added was an amount corresponding to 1.0 wt % of the total amount of the Ag powder.

### EXAMPLE 22

### Preparation of Conductor Paste (22)

In this example, a paste containing the bismuth oxide powder and the lead glass powder described above as inorganic additives was prepared. More specifically, the Al-coated Ag powder obtained in Example 3 and the bismuth oxide powder and the lead glass were used, and these materials were weighed such that the final paste concentration (weight ratio) was 87 wt % for the Al-coated Ag powder and the remaining for a solvent (terpineol), and further the bismuth oxide powder in an amount corresponding to 0.5 wt % and the lead glass powder in an amount corresponding to 0.25 wt % of the total amount of the Ag powder are added thereto, followed by kneading with a three-roll mill. Thus, a conductor paste was obtained.

### EXAMPLE 23

### Preparation of Conductor Paste (23)

In this example, as the base of the metal powder, a fine Ag powder having an average particle size of 0.3 to 0.5 μm was used. The same process as in Example 3 was performed, so that an Ag powder whose surface was coated substantially uniformly with the aluminum alkoxide in an amount corresponding to about 0.05 wt % of the total amount of the Ag powder in terms of aluminum oxide (Al₂O₃) was obtained.

Thus, a conductor paste containing a bismuth oxide powder (in an amount corresponding to about 0.5 wt % of the total amount of the Ag powder) as an inorganic additive was prepared by performing the same process in Example 20, except that the Al-coated Ag powder was used.

### EXAMPLE 24

### Preparation of Conductor Paste (24)

In this example, as the base of the metal powder, a fine Ag powder having an average particle size of 0.3 to 0.5 μm was used (however, this example is different from Example 23 in the manufacturer of the Ag powder). The same process as in Example 3 was performed, so that an Ag powder whose surface was coated substantially uniformly with the aluminum alkoxide in an amount corresponding to about 0.05 wt % of the total amount of the Ag powder in terms of aluminum oxide (Al₂O₃) was obtained.

Thus, a conductor paste containing a bismuth oxide powder (in an amount corresponding to about 0.5 wt % of the total amount of the Ag powder) as an inorganic additive was prepared by performing the same process in Example 20, except that the Al-coated Ag powder was used.

### EXAMPLE 25

### Preparation of Conductor Paste (25)

In this example, as the base of the metal powder, an Ag powder having an average particle size of 0.5 to 0.7 μm was used. The same process as in Example 3 was performed, so that an Ag powder whose surface was coated substantially uniformly with the aluminum alkoxide in an amount corresponding to about 0.05 wt % of the total amount of the Ag powder in terms of aluminum oxide (Al₂O₃) was obtained.

Thus, a conductor paste containing a bismuth oxide powder (in an amount corresponding to about 0.5 wt % of the total amount of the Ag powder) as an inorganic additive was prepared by performing the same process in Example 20, except that the Al-coated Ag powder was used.

### EXAMPLE 26

### Preparation of Conductor Paste (26)

In this example, a paste containing the bismuth oxide powder and the copper oxide powder described above as inorganic additives was prepared. More specifically, the Al-coated Ag powder obtained in Example 3 and the bismuth oxide powder and the cupper oxide powder were used, and these materials were weighed such that the final paste concentration (weight ratio) was 87 wt % for the Al-coated Ag powder and the remaining for a solvent (terpineol), and further the bismuth oxide powder in an amount corresponding to 0.5 wt % and the cupper oxide powder in an amount corresponding to 0.5 wt % of the total amount of the Ag powder are added thereto, followed by kneading with a three-roll mill. Thus, a conductor paste was obtained.

### EXAMPLE 27

### Preparation of Conductor Paste (27)

A conductor paste was prepared by performing the same process as in Example 26, except the amount of the cupper oxide powder added was an amount corresponding to 0.25 wt % of the total amount of the Ag powder.

### EXAMPLE 28

### Preparation of Conductor Paste (28)

A conductor paste was prepared by performing the same process as in Example 26, except the amount of the cupper oxide powder added was an amount corresponding to 0.125 wt % of the total amount of the Ag powder.

### COMPARATIVE EXAMPLE 1

### Preparation of Conductor Paste (29)

In this comparative example, as the base of the metal powder, an Ag powder having an average particle size of 2.0 to 3.0 μm was used. Coating with an organic metal compound was not performed. In other words, the non-coated Ag powder was used as it was, and these materials were weighed such that the final paste concentration (weight ratio) was 87 wt % for the Ag powder and the remaining for a solvent (terpineol), followed by kneading with a three-roll mill. Thus, a conductor paste was obtained.

### COMPARATIVE EXAMPLE 2

### Preparation of Conductor Paste (30)

In this comparative example, as the base of the metal powder, an Ag powder having an average particle size of about 1.0 μm was used. Coating with an organic metal compound was not performed.

Thus, a conductor paste containing a bismuth oxide powder and a cupper oxide powder (each in an amount corresponding to about 0.5 wt % of the total amount of the Ag powder) as an inorganic additive was prepared by performing the same process in Example 26, except that such a non-coated Ag powder was used.

The average particle size of the Ag powder, the coating amount of the organic metal compound (i.e., aluminum alkoxide or zirconium alkoxide), the type of the inorganic additive and the addition amount thereof in the examples and the comparative examples described above are shown in the respective fields in Tables 1 to 10.

TABLE 1

| | | | | | | | | | | Comparative | | |
|---|---|---|---|---|---|---|---|---|---|---|---|---|
| conductor paste | Example 1 | | | Example 2 | | | Example 3 | | | Example 1 | | |
| Ag average | 0.8-1.0 (0.8 >> 1.0) | | | 0.8-1.0 (0.8 >> 1.0) | | | 0.8-1.0 (0.8 >> 1.0) | | | 2.0-3.0 | | |
| particle size (μm) | | | | | | | | | | | | |
| coating amount | 0.0125(Al₂O₃) | | | 0.025(Al₂O₃) | | | 0.050(Al₂O₃) | | | no coating | | |
| (wt %) | | | | | | | | | | | | |
| inorganic | not added | | | not added | | | not added | | | not added | | |
| additive | | | | | | | | | | | | |
| addition amount | — | | | — | | | — | | | — | | |
| (wt %) | | | | | | | | | | | | |
| coating thickness | n.d. | n.d. | n.d. | n.d. | n.d. | n.d. | n.d. | n.d. | n.d. | — | n.d. | n.d. |
| (μm) | | | | | | | | | | | | |
| Firing | 800 | 850 | 900 | 800 | 850 | 900 | 800 | 850 | 900 | — | 850 | 900 |
| temperature (° C.) | | | | | | | | | | | | |
| thickness of fired | 19.9 | 19.5 | 18.3 | 20.9 | 19.9 | 16.6 | 21.8 | 19.9 | 16.8 | — | 8.5 | 8.1 |
| film (μm) | | | | | | | | | | | | |
| resistance (Ω) | 0.26 | 0.249 | 0.235 | 0.294 | 0.263 | 0.238 | 0.360 | 0.316 | 0.265 | — | n.d. | n.d. |
| sheet resistance | 2.59 | 2.43 | 2.15 | 3.07 | 2.62 | 1.98 | 3.92 | 3.14 | 2.23 | — | 2.5 | 2.1 |
| (mΩ/□) | | | | | | | | | | | | |
| solder wettability | ⊚ | ⊚ | ⊚ | ⊚ | ⊚ | ⊚ | ⊚ | ⊚ | ⊚ | — | ⊚ | ⊚ |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | ⊚ | ⊚ | ⊚ | — | ⊚ | ⊚ |
| 260° C. × 10 sec | ⊚ | ⊚ | ⊚ | ⊚ | ⊚ | ⊚ | ⊚ | ⊚ | ⊚ | — | X | X |
| 260° C. × 20 sec | ⊚ | ⊚ | ⊚ | ⊚ | ⊚ | ⊚ | ⊚ | ⊚ | ⊚ | — | X | X |
| Tensile strength | n.d. | n.d. | 1.07 | n.d. | n.d. | 2.63 | n.d. | n.d. | 3.09 | — | n.d. | n.d. |
| (kg) early stage | | | | | | | | | | | | |

TABLE 2

| conductor paste | Example 4 | | | Example 5 | | | Example 6 | | | Example 7 | | |
|---|---|---|---|---|---|---|---|---|---|---|---|---|
| Ag average | 0.8-1.0 (0.8 << 1.0) | | | 0.8-1.0 (0.8 << 1.0) | | | 0.8-1.0 (0.8 << 1.0) | | | 0.8-1.0 (0.8 << 1.0) | | |
| particle size | | | | | | | | | | | | |
| (μm) | | | | | | | | | | | | |
| coating amount | 0.0125(Al₂O₃) | | | 0.025(Al₂O₃) | | | 0.050(Al₂O₃) | | | 0.1(ZrO₂) | | |
| (wt %) | | | | | | | | | | | | |
| inorganic | not added | | | not added | | | not added | | | not added | | |
| additive | | | | | | | | | | | | |
| addition amount | — | | | — | | | — | | | — | | |
| (wt %) | | | | | | | | | | | | |
| coating | n.d. | n.d. | n.d. | n.d. | n.d. | n.d. | n.d. | n.d. | n.d. | — | — | n.d. |
| thickness (μm) | | | | | | | | | | | | |
| Firing | 800 | 850 | 900 | 800 | 850 | 900 | 800 | 850 | 900 | — | — | 900 |
| temperature (° C.) | | | | | | | | | | | | |
| thickness of | 16.3 | 15.1 | 14.0 | 15.9 | 14.9 | 13.5 | 21.8 | 18.3 | 15.4 | — | — | 9.06 |
| fired film (μm) | | | | | | | | | | | | |
| resistance (Ω) | 0.315 | 0.290 | 0.271 | 0.362 | 0.316 | 0.285 | 0.561 | 0.383 | 0.288 | — | — | 0.398 |
| sheet resistance | 2.57 | 2.19 | 1.90 | 2.88 | 2.35 | 1.92 | 6.11 | 3.50 | 2.22 | — | — | 1.8 |
| (mΩ/□) | | | | | | | | | | | | |
| solder | ⊚ | ⊚ | ⊚ | ⊚ | ⊚ | ⊚ | ⊚ | ⊚ | ⊚ | — | — | ⊚ |
| wettability | | | | | | | | | | | | |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | ⊚ | ⊚ | ⊚ | — | — | ⊚ |
| 260° C. × 10 sec | ⊚ | ⊚ | ⊚ | ⊚ | ⊚ | ⊚ | ⊚ | ⊚ | ⊚ | — | — | ⊚ |
| 260° C. × 20 sec | ⊚ | ⊚ | ⊚ | ⊚ | ⊚ | ⊚ | ⊚ | ⊚ | ⊚ | — | — | ⊚ |
| Tensile strength | n.d. | n.d. | 0.97 | n.d. | n.d. | 0.45 | n.d. | n.d. | 0.14 | — | — | 0.1 |
| (kg) early stage | | | | | | | | | | | | |

TABLE 3

| conductor paste | Example 8 | | | Example 9 | | | Example 10 | | | Example 11 | | |
|---|---|---|---|---|---|---|---|---|---|---|---|---|
| Ag average particle | 0.8-1.0 (0.8 >> 1.0) | | | 0.8-1.0 (0.8 >> 1.0) | | | 0.8-1.0 (0.8 >> 1.0) | | | 0.8-1.0 (0.8 >> 1.0) | | |
| size (μm) | | | | | | | | | | | | |
| coating amount | 0.050 (Al₂O₃) | | | 0.050 (Al₂O₃) | | | 0.050 (Al₂O₃) | | | 0.050 (Al₂O₃) | | |
| (wt %) | | | | | | | | | | | | |
| inorganic additive | zinc glass (780° C.) | | | lead glass (700° C.) | | | lead glass (700° C.) | | | lead glass (700° C.) | | |
| addition amount | 0.50 | | | 0.25 | | | 0.50 | | | 1.00 | | |
| (wt %) | | | | | | | | | | | | |
| coating thickness | 29.3 | 29.3 | 29.3 | 28.5 | 28.5 | 28.5 | 29.8 | 29.8 | 29.8 | 28.1 | 28.1 | 28.1 |
| (μm) | | | | | | | | | | | | |
| Firing temperature | 800 | 850 | 900 | 800 | 850 | 900 | 800 | 850 | 900 | 800 | 850 | 900 |
| (° C.) | | | | | | | | | | | | |
| thickness of fired | 14.8 | 15.0 | 15.1 | 16.0 | 16.0 | 16.0 | 16.6 | 17.1 | 16.6 | 16.9 | 15.5 | 15.5 |
| film (μm) | | | | | | | | | | | | |
| sheet resistance | 4.0 | 3.4 | 2.6 | 2.1 | 2.1 | 2.1 | 2.3 | 2.1 | 2.1 | 2.3 | 2.1 | 2.1 |
| (mΩ/□) | | | | | | | | | | | | |
| solder wettability | ⊚ | ⊚ | ⊚ | ⊚ | ⊚ | ⊚ | X | X | X | X | X | X |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | X | X | ◯ | X | X | X |
| 260° C. × 10 sec | ⊚ | ⊚ | ⊚ | ⊚ | ⊚ | ⊚ | X | X | ◯ | X | X | X |
| 260° C. × 20 sec | ⊚ | ⊚ | ⊚ | ⊚ | ⊚ | ⊚ | X | X | ◯ | X | X | X |
| Tensile strength (kg) | | | | | | | | | | | | |
| early stage | n.d. | n.d. | 3.93 | 3.57 | 3.73 | 3.89 | 3.23 | 3.44 | 3.61 | 1.91 | 3.55 | 2.53 |
| after 48 hour aging | n.d. | n.d. | 4.29 | 2.01 | 2.91 | 3.52 | 2.94 | 2.60 | 2.57 | n.d. | 2.34 | 2.39 |
| after 100 hour aging | n.d. | n.d. | 2.39 | 1.88 | 2.44 | 3.23 | 1.79 | 2.33 | 1.75 | 1.00 | 1.37 | 2.07 |

TABLE 4

| conductor paste | Example 12 | | | Example 3 (reference) | | |
|---|---|---|---|---|---|---|
| Ag average particle size | 0.8-1.0 (0.8 >> 1.0) | | | 0.8-1.0 (0.8 >> 1.0) | | |
| (μm) | | | | | | |
| coating amount (wt %) | 0.050 (Al₂O₃) | | | 0.050 (Al₂O₃) | | |
| inorganic additive | borosilicate glass (725° C.) | | | not added | | |
| addition amount (wt %) | 0.50 | | | — | | |
| coating thickness (μm) | 29.3 | 29.3 | 29.3 | 28.3 | 28.3 | 28.3 |
| Firing temperature (° C.) | 800 | 850 | 900 | 800 | 850 | 900 |
| thickness of fired film | 15.9 | 16.1 | 16.8 | 20.9 | 18.1 | 14.9 |
| (μm) | | | | | | |
| sheet resistance (mΩ/□) | 2.2 | 2.2 | 2.3 | 4.3 | 3.2 | 2.3 |
| solder wettability (230° C. × 3 sec) | X | X | ⊚ | ⊚ | ⊚ | ⊚ |
| resistance to soldering heat | | | | | | |
| 230° C. × 30 sec | X | X | ⊚ | ⊚ | ⊚ | ⊚ |
| 260° C. × 10 sec | X | X | ⊚ | ⊚ | ⊚ | ⊚ |
| 260° C. × 20 sec | X | X | ◯ | ⊚ | ⊚ | ⊚ |
| Tensile strength (kg) | | | | | | |
| early stage | 0.95 | 4.14 | 4.13 | n.d. | n.d. | 2.05 |
| after 48 hour aging | n.d. | 3.44 | 4.95 | n.d. | n.d. | 1.00 |
| after 100 hour aging | n.d. | 3.05 | 3.28 | n.d. | n.d. | 1.00 |

TABLE 5

| conductor paste | Example 13 | | | Example 14 | | | Example 15 | | | Comparative Example 2 | | |
|---|---|---|---|---|---|---|---|---|---|---|---|---|
| Ag average particle | 0.8-1.0 (0.8 >> 1.0) | | | 0.8-1.0 (0.8 >> 1.0) | | | 0.8-1.0 (0.8 >> 1.0) | | | about 1.0 | | |
| size (μm) | | | | | | | | | | | | |
| coating amount | 0.050(Al₂O₃) | | | 0.050(Al₂O₃) | | | 0.050(Al₂O₃) | | | no coating | | |
| (wt %) | | | | | | | | | | | | |
| inorganic additive | Cu₂O | | | Cu₂O | | | Cu₂O | | | Cu₂O + Bi₂O₃ | | |
| addition amount | 0.25 | | | 0.50 | | | 1.00 | | | 0.50 + 0.50 | | |
| (wt %) | | | | | | | | | | | | |
| coating thickness | 28.0 | 28.0 | 28.0 | 28.2 | 28.2 | 28.2 | 25.1 | 25.1 | 25.1 | 12.1 | 12.1 | 12.1 |
| (μm) | | | | | | | | | | | | |
| Firing temperature | 800 | 850 | 900 | 800 | 850 | 900 | 800 | 850 | 900 | 800 | 850 | 900 |
| (° C.) | | | | | | | | | | | | |
| thickness of fired | 16.8 | 16.0 | 16.9 | 16.0 | 15.1 | 15.4 | 15.1 | 13.9 | 14.1 | 6.25 | 6.5 | 6.75 |
| film (μm) | | | | | | | | | | | | |
| sheet resistance | 2.4 | 2.2 | 2.4 | 2.2 | 2.1 | 2.2 | 2.4 | 2.1 | 2.1 | 2.3 | 2.2 | 2.3 |
| (mΩ/□) | | | | | | | | | | | | |
| solder wettability | ⊚ | ⊚ | ⊚ | ⊚ | ⊚ | ⊚ | ⊚ | ⊚ | ⊚ | ⊚ | ⊚ | ⊚ |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | ⊚ | ⊚ | n.d. | ◯ | ◯ | ◯ |
| 260° C. × 10 sec | ⊚ | ⊚ | ⊚ | ⊚ | ⊚ | ⊚ | ◯ | ◯ | ◯ | X | X | X |
| 260° C. × 20 sec | ⊚ | ⊚ | ⊚ | ⊚ | ⊚ | ⊚ | ⊚ | ◯ | ◯ | X | X | X |
| Tensile strength (kg) | | | | | | | | | | | | |
| early stage | n.d. | 4.06 | 4.59 | n.d. | 3.26 | 3.74 | n.d. | 3.79 | 4.42 | 4.42 | 3.92 | 4.94 |
| after 48 hour aging | n.d. | 2.46 | 4.42 | n.d. | 3.49 | n.d. | n.d. | 3.71 | 4.63 | n.d. | n.d. | n.d. |
| after 100 hour aging | n.d. | 2.19 | 4.44 | n.d. | 2.83 | 3.22 | n.d. | 2.60 | 3.99 | <1.0 | <1.0 | 2.40 |

TABLE 6

| conductor paste | Example 16 | | | Example 17 | | | Example 18 | | |
|---|---|---|---|---|---|---|---|---|---|
| Ag average particle size | 0.8-1.0 (0.8 >> 1.0) | | | 0.8-1.0 (0.8 >> 1.0) | | | 0.8-1.0 (0.8 >> 1.0) | | |
| (μm) | | | | | | | | | |
| coating amount (wt %) | 0.050(Al₂O₃) | | | 0.050(Al₂O₃) | | | 0.050(Al₂O₃) | | |
| inorganic additive | Pb₃O₄ | | | Pb₃O₄ | | | Pb₃O₄ | | |
| addition amount (wt %) | 0.25 | | | 0.50 | | | 1.00 | | |
| coating thickness (μm) | 21.1 | 21.1 | 21.1 | 27.8 | 27.8 | 27.8 | 21.3 | 21.3 | 21.3 |
| Firing temperature (° C.) | 800 | 850 | 900 | 800 | 850 | 900 | 800 | 850 | 900 |
| thickness of fired film | 11.5 | 12.9 | 13.9 | 16.0 | 15.6 | 15.5 | 12.1 | 11.6 | 12.3 |
| (μm) | | | | | | | | | |
| sheet resistance (mΩ/□) | 2.0 | 2.0 | 1.9 | 2.2 | 2.1 | 2.1 | 2.0 | 1.9 | 1.9 |
| solder wettability (230° C. × 3 sec) | ⊚ | ⊚ | ⊚ | ⊚ | ⊚ | ⊚ | ⊚ | ⊚ | ⊚ |
| resistance to soldering heat | | | | | | | | | |
| 230° C. × 30 sec | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ |
| 260° C. × 20 sec | ⊚ | ⊚ | ⊚ | ⊚ | ⊚ | ⊚ | ⊚ | ⊚ | ⊚ |
| Tensile strength (kg) | | | | | | | | | |
| early stage | n.d. | n.d. | 3.44 | 3.36 | 3.90 | 3.96 | 3.33 | 3.51 | 4.29 |
| after 48 hour aging | n.d. | n.d. | n.d. | 3.04 | 3.05 | 3.19 | n.d. | n.d. | n.d. |
| after 100 hour aging | n.d. | n.d. | 3.10 | 2.34 | 1.79 | 3.89 | 2.40 | 2.77 | 3.25 |

TABLE 7

| conductor paste | Example 19 | | | Example 20 | | | Example 21 | | |
|---|---|---|---|---|---|---|---|---|---|
| Ag average particle size | 0.8-1.0 (0.8 >> 1.0) | | | 0.8-1.0 (0.8 >> 1.0) | | | 0.8-1.0 (0.8 >> 1.0) | | |
| (μm) | | | | | | | | | |
| coating amount (wt %) | 0.050(Al₂O₃) | | | 0.050(Al₂O₃) | | | 0.050(Al₂O₃) | | |
| inorganic additive | Bi₂O₃ | | | Bi₂O₃ | | | Bi₂O₃ | | |
| addition amount (wt %) | 0.25 | | | 0.50 | | | 1.00 | | |
| coating thickness (μm) | 22.1 | 22.1 | 22.1 | 22.9 | 22.9 | 22.9 | 20.5 | 20.5 | 20.5 |
| Firing temperature (° C.) | 800 | 850 | 900 | 800 | 850 | 900 | 800 | 850 | 900 |
| thickness of fired film | 13.1 | 14.0 | 14.4 | 13.1 | 13.6 | 14.1 | 11.8 | 11.3 | 11.3 |
| (μm) | | | | | | | | | |
| sheet resistance (mΩ/□) | 2.1 | 2.3 | 2.3 | 1.9 | 2.2 | 2.2 | 2.0 | 2.0 | 1.9 |
| solder wettability (230° C. × 3 sec) | ⊚ | ⊚ | ⊚ | ⊚ | ⊚ | ⊚ | ⊚ | ⊚ | ⊚ |
| resistance to soldering heat | | | | | | | | | |
| 230° C. × 30 sec | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ |
| 260° C. × 20 sec | ⊚ | ⊚ | ⊚ | ⊚ | ⊚ | ⊚ | ◯ | ⊚ | ⊚ |
| Tensile strength (kg) | | | | | | | | | |
| early stage | <1.0 | 1.88 | 3.97 | 2.44 | 2.83 | 3.83 | 3.30 | 3.66 | 3.72 |
| after 48 hour aging | n.d. | n.d. | n.d. | n.d. | n.d. | n.d. | n.d. | n.d. | n.d. |
| after 100 hour aging | <1.0 | 1.14 | 3.74 | 1.22 | 2.14 | 3.52 | 2.93 | 3.21 | 3.09 |

TABLE 8

| conductor paste | Example 22 | | | Example 23 | | | Example 24 | | | Example 25 | | |
|---|---|---|---|---|---|---|---|---|---|---|---|---|
| Ag average particle | 0.8-1.0 (0.8 >> 1.0) | | | 0.3-0.5 | | | 0.3-0.5 | | | 0.5-0.7 | | |
| size (μm) | | | | | | | | | | | | |
| coating amount | 0.050(Al₂O₃) | | | 0.050(Al₂O₃) | | | 0.050(Al₂O₃) | | | 0.050(Al₂O₃) | | |
| (wt %) | | | | | | | | | | | | |
| inorganic additive | Bi₂O₃ + lead glass | | | Bi₂O₃ | | | Bi₂O₃ | | | Bi₂O₃ | | |
| addition amount | 0.50 + 0.25 | | | 0.50 | | | 0.50 | | | 0.50 | | |
| (wt %) | | | | | | | | | | | | |
| coating thickness | 22.3 | 22.3 | 22.3 | 17.1 | 17.1 | 17.1 | 21.1 | 21.1 | 21.1 | 23.8 | 23.8 | 23.8 |
| (μm) | | | | | | | | | | | | |
| Firing temperature | 800 | 850 | 900 | 800 | 850 | 900 | 800 | 850 | 900 | 800 | 850 | 900 |
| (° C.) | | | | | | | | | | | | |
| thickness of fired | 12.6 | 12.5 | 12.1 | 10.8 | 13.1 | 11.4 | 11.3 | 11.8 | 11.9 | 13.0 | 13.3 | 14.1 |
| film (μm) | | | | | | | | | | | | |
| sheet resistance | 2.1 | 1.9 | 1.9 | 2.1 | 2.1 | 2.1 | 2.1 | 2.1 | 2.0 | 2.3 | 2.1 | 2.2 |
| (mΩ/□) | | | | | | | | | | | | |
| solder wettability | ⊚ | ⊚ | ⊚ | ⊚ | ⊚ | ⊚ | ⊚ | ⊚ | ⊚ | ⊚ | ⊚ | ⊚ |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ | ⊚ | ⊚ | ⊚ |
| 260° C. × 20 sec | ◯ | ◯ | ◯ | ⊚ | ⊚ | ⊚ | ◯ | ◯ | ⊚ | ◯ | ⊚ | ⊚ |
| Tensile strength (kg) | | | | | | | | | | | | |
| early stage | 3.78 | 3.58 | 3.79 | n.d. | 3.80 | 4.32 | 2.99 | 2.87 | 3.96 | n.d. | 2.13 | 3.88 |
| after 100 hour aging | 2.63 | 2.10 | 2.63 | <1.0 | 2.31 | n.d. | <1.0 | 2.54 | 3.29 | <1.0 | 1.48 | 3.03 |

TABLE 9

| conductor paste | Example 26 | | | | | Example 27 | | | | |
|---|---|---|---|---|---|---|---|---|---|---|
| Ag average particle size | 0.8-1.0 (0.8 >> 1.0) | | | | | 0.8-1.0 (0.8 >> 1.0) | | | | |
| (μm) | | | | | | | | | | |
| coating amount (wt %) | 0.050(Al₂O₃) | | | | | 0.050(Al₂O₃) | | | | |
| inorganic additive | Bi₂O₃ + Cu₂O | | | | | Bi₂O₃ + Cu₂O | | | | |
| addition amount (wt %) | 0.50 + 0.50 | | | | | 0.50 + 0.25 | | | | |
| coating thickness (μm) | 20.6 | | | | | 21.3 | | | | |
| Firing temperature (° C.) | 700 | 750 | 800 | 850 | 900 | 700 | 750 | 800 | 850 | 900 |
| thickness of fired film | 14.93 | 12.88 | 8.2 | 8.98 | 9.85 | 14.65 | 12.9 | 12.15 | 12.68 | 12.75 |
| (μm) | | | | | | | | | | |
| solder wettability (230° C. × 3 sec) | ⊚ | ⊚ | ⊚ | ⊚ | ⊚ | ⊚ | ⊚ | ⊚ | ⊚ | ⊚ |
| resistance to soldering heat | | | | | | | | | | |
| 230° C. × 30 sec | ⊚ | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ | ⊚ |
| 260° C. × 20 sec | ◯ | ◯ | ◯ | ◯ | ◯ | ⊚ | ⊚ | ⊚ | ⊚ | ⊚ |
| Tensile strength (kg) | | | | | | | | | | |
| early stage | n.d. | 2.74 | 3.75 | 3.75 | 4.21 | n.d. | 4.27 | 4.35 | 5.35 | 4.49 |
| after 100 hour aging | n.d. | 1.00 | 3.04 | 3.7 | 4.48 | n.d. | 0.66 | 3.65 | 4.71 | 4.68 |
| after 200 hour aging | n.d. | 0.45 | 0.97 | 3.68 | 2.76 | n.d. | 0.50 | 3.11 | 3.99 | 4.11 |

TABLE 10

| conductor paste | Example 28 | | | | | Example 20 (reference) | | | | |
|---|---|---|---|---|---|---|---|---|---|---|
| Ag average particle size | 0.8-1.0 (0.8 >> 1.0) | | | | | 0.8-1.0 (0.8 >> 1.0) | | | | |
| (μm) | | | | | | | | | | |
| coating amount (wt %) | 0.050(Al₂O₃) | | | | | 0.050(Al₂O₃) | | | | |
| inorganic additive | Bi₂O₃ + Cu₂O | | | | | Bi₂O₃ | | | | |
| addition amount (wt %) | 0.50 + 0.125 | | | | | 0.50 | | | | |
| coating thickness (μm) | 21.3 | | | | | 16.4 | | | | |
| Firing temperature (° C.) | 700 | 750 | 800 | 850 | 900 | 700 | 750 | 800 | 850 | 900 |
| thickness of fired film | 14.23 | 13.45 | 12.45 | 12.53 | 11.88 | 12.13 | 11.1 | 10.58 | 10 | 9.43 |
| (μm) | | | | | | | | | | |
| solder wettability (230° C. × 3 sec) | ⊚ | ⊚ | ⊚ | ⊚ | ⊚ | ⊚ | ⊚ | ⊚ | ⊚ | ⊚ |
| resistance to soldering heat | | | | | | | | | | |
| 230° C. × 30 sec | ⊚ | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ | ⊚ |
| 260° C. × 20 sec | ⊚ | ⊚ | ⊚ | ⊚ | ⊚ | ⊚ | ⊚ | ⊚ | ⊚ | ⊚ |
| Tensile strength (kg) | | | | | | | | | | |
| early stage | n.d. | 2.61 | 4.53 | 3.65 | 4.34 | n.d. | n.d. | 3.31 | 4.05 | 3.36 |
| after 100 hour aging | n.d. | 0.52 | 4.00 | 4.37 | 4.02 | n.d. | n.d. | 3.13 | 3.28 | 3.29 |
| after 200 hour aging | n.d. | 0.27 | 2.68 | 3.5 | 4.66 | n.d. | n.d. | 2.28 | 1.85 | 2.72 |

### EXAMPLE 29

### Formation of a Film Conductor and Evaluation thereof (1)

A film conductor was formed on the surface of a ceramic base material (an alumina substrate having a thickness of about 0.8 mm in this example), using the conductor pastes of the examples and the comparative examples. More specifically, the conductor paste was applied onto the surface of the ceramic substrate according to commonly used screen printing, and a coating film having a predetermined thickness (10 to 30 μm: refer to the field “coating thickness” in the tables) was formed.

Then, a drying treatment was performed with a dryer using far infrared radiation at 100° C. for 15 minutes. This drying treatment volatilized the solvent from the coating film, and thus an unfired film conductor was formed on the ceramic substrate.

Then, this film conductor together with the ceramic substrate was fired, specifically, in an electrical furnace at an either temperature of 700, 750, 800, 850 and 900° C. (depending on the paste used, refer to the field “firing temperature” in the tables) for one hour. With this firing treatment, the film conductor having a predetermined thickness (refer to the field “thickness of fired film”) was attached onto the ceramic substrate. Hereinafter, “film conductor” refers to this product after firing.

Next, in order to evaluate the characteristics of each of the obtained film conductors, the value of resistance, the sheet resistance value, the solder wettability, the resistance to soldering heat and the tensile strength were tested and measured in the following manner. The results of the evaluation test of the characteristics are shown in the respective fields in Tables 1 to 10 for each paste used. In the tables, “n.d.” indicates non-measurement.

<Measurement of Resistance>

The value of resistance (Ω) of each of the film conductors obtained using the conductor pastes of Examples 1 to 7 was measured in the following manner. The value of resistance (Ω) of the film conductor was measured based on a commonly used two-terminal technique with a commercially available digital multimeter. For reference, an equation for calculating the volume resistivity value is shown below:

The volume resistivity value (Ω·cm)=(R×t×W)/L

R: the value of resistance between electrodes (Ω), t: thickness of a film conductor (cm), W: width of a film conductor, and L: distance between electrodes (cm)

<Measurement of Sheet Resistance Value>

The sheet resistance value (mΩ/) of each of the film conductors obtained using the conductor pastes of Examples 1 to 25 and Comparative Examples 1 and 2 was measured in the following manner. The sheet resistance value (mΩ) was calculated based on the value of the resistance (Ω) measured above.

The sheet resistance value (mΩ/)=measured value of resistance (Ω)×(conductor width (mm)/conductor length (mm))×(conductor thickness (μm)/converted thickness (μm)); Here, the converted thickness is 10 μm for fired products and 25 μm for printed matters.

<Solder Wettability>

The solder wettability of each of the film conductors obtained using the conductor pastes of the examples and the comparative examples was investigated in the following manner. A rosin flux was applied to a film conductor portion of each ceramic substrate, and then the substrate was immersed in a solder (Sn/Pb=60/40 (weight ratio)) having 230±5° C. for three seconds. Thereafter, the solder wettability was evaluated using the area ratio of the film conductor portion wetted with the solder. More specifically, those in which 90% or more of the surface of the film conductor was wetted are determined to have good solder wettability and are shown by “⊚”. On the other hand, those in which 80% or less of the entire surface of the film conductor was wetted with the solder are determined to have poor solder wettability and are shown by “X”.

<Resistance to Soldering Heat>

The resistance to soldering heat of each of the film conductors obtained using the conductor pastes of the examples and Comparative Example 2 was investigated in the following manner. A rosin flux was applied to a film conductor portion of each ceramic substrate, and then the substrate was immersed in a solder (Sn/Pb=60/40 (weight ratio)) having a predetermined temperature for a predetermined time. The soldering temperature and the immersing time were three types, that is, 230±5° C.×30 seconds, 260±5° C.×10 seconds and 260±5° C.×20 seconds (The condition applied depends on the paste used. Refer to the field “resistance to soldering heat in the tables).

Thus, the resistance to soldering heat was evaluated with the area ratio of the portion in which “solder leaching” substantially did not occur after immersion, that is the film conductor that was left on the ceramic substrate after immersion in comparison with before immersion. More specifically, those in which 90% or more of the film conductor was left are determined to have excellent resistance to soldering heat and are shown by “⊚”. Those in which about 80% or more and less than 90% of the film conductor was left are determined to have good resistance to soldering heat and are shown by “◯”. On the other hand, those in which about 80% or less of the film conductor was left in comparison with before immersion are determined to have poor resistance to soldering heat and are shown by “X”.

<Tensile Strength>

The tensile strength (kg) of each of the film conductors obtained using the conductor paste of the examples and Comparative Example 2 was investigated as an indicator of the bond strength with respect to the ceramic substrate in the following manner. A lead wire (tin-plated copper wire) for evaluation was soldered onto the film conductor formed on the ceramic substrate by firing for attachment. Thereafter, the lead wire was pulled by a predetermined force to the direction perpendicular to the plane direction of the substrate, and the load (kg) at the time when the joined surface was broken (split) was taken as the bond strength (tensile strength). Herein, the tensile strength tests were performed with respect to the ceramic substrates immediately after the firing treatment and the ceramic substrates that were subjected to aging at 150° C. for 48 hours, 100 hours or 200 hours after firing (The condition depends on the paste used. Refer to the field “tensile strength” in the tables).

As seen from the results of the evaluation tests of the characteristics shown in Tables 1 to 10, the film conductors (thickness: 10 to 22 μm) formed of the conductor pastes of the examples of the present invention exhibit values of resistance and/or sheet resistance values that cause no problems when serving as conductors. These results show that the conductor pastes of the present invention can be preferably used to form film conductor in view of the conductivity and the electrical characteristics.

Regarding the solder wettability, although the samples obtained by adding a comparatively large amount of lead glass powder or borosilicate glass powder (Examples 10, 11, and 12) had slightly poor solder wettability (approximately 50% to 70%), the indicator values of the solder wettability of the other samples were 90% or more (“⊚” in the tables). This indicates that the conductor pastes of the present invention can be preferably used to form film conductor in view of the solder wettability. When glass powder is added, zinc glass powder is comparatively preferable (Example 8).

As seen from the evaluation tests of the resistance to soldering heat, the film conductors formed of the conductor pastes of the examples exhibit resistance to soldering heat that is equal to or more than that of the film conductors formed of conventional conductor pastes containing Ag/Pd powder or Ni-plated film conductors. In particular, it was confirmed that even the pastes prepared without adding an inorganic additive (Examples 1 to 7) had high resistance to soldering heat (Examples 1 to 7). This indicates that according to the present invention, Ag based particulates are coated with a very small amount of about 0.01 wt % (in terms of oxide) with respect to the metal (Ag) powder of an organic metal compound (metal alkoxide herein), so that high resistance to soldering heat of practical level can be realized without using expensive Pd or performing a bothering Ni plating treatment.

As seen from the evaluation tests of the tensile strength, the film conductors formed of the conductor pastes of the present invention turned out to have bond strength of practical level without requiring an additive, because they are fired products of Ag based particulates (Examples 1 to 7). The results of using the pastes of the examples in which inorganic additives were added indicate that adding a suitable amount of glass frit and/or inorganic oxide powder improves the bond strength while maintaining desired resistance to soldering heat and solder wettability (refer to Examples 3, 13 to 15, for example). In particular, adding a suitable amount of inorganic oxide is effective. Such addition can realize both maintenance of high solder wettability and resistance to soldering heat and improvement of bond strength (refer to Examples 13 to 28). Furthermore, it contributes to reduction of firing shrinkage. One type of inorganic oxide may be added, but it has been shown that it is preferable to add two or more types of inorganic oxide in combination (refer to Examples 26 to 28).

The average particle size (0.2 to 1.0 μm) of the Ag powder used in the examples were suitable to prepare the conductor pastes of the present invention (refer to Examples 20, 23, 24, and 25). It has been confirmed that that the firing temperature of the film conductors when the conductor pastes of the examples are used is preferably 800° C. in view of the maintenance of comparatively high bond strength, and particularly preferably 850 to 900° C.

### EXAMPLE 30

### Formation of a Film Conductor and Evaluation thereof (2)

In order to confirm that the conductor pastes disclosed in the present specification can be formed into a thin film conductor (typically 10 μm or less) more preferably than the pastes of the comparative examples, a comparatively thick film conductor and a comparatively thin film conductor were formed using the four conductor pastes of Examples 17, 20, 22 and Comparative Example 2, and the characteristics thereof were evaluated in the same manner as in Example 29.

More specifically, as in Example 29, each conductor paste was applied onto the surface of a ceramic substrate according to screen printing, and a thin coating film and a thick coating film were formed for each paste. Thereafter, a firing treatment was performed in the same manner as in Example 29 so that a comparatively thick film conductor (thickness: 12 to 15 μm) and a comparatively thin film conductor (thickness: 6 to 8 μm) were formed.

Next, in order to evaluate the characteristics of each of the obtained film conductors, the sheet resistance value, the solder wettability, the resistance to soldering heat and tensile strength were tested and measured in the same manner as in the above example. Tables 11 and 12 below show the results.

TABLE 11

| conductor paste | Example 17 | | | Example 17 | | | Example 20 | | | Example 20 | | |
|---|---|---|---|---|---|---|---|---|---|---|---|---|
| Ag average particle | 0.8˜1.0(0.8 >> 1.0) | | | 0.8˜1.0(0.8 >> 1.0) | | | 0.8˜1.0(0.8 >> 1.0) | | | 0.8˜1.0(0.8 >> 1.0) | | |
| size(μm) | | | | | | | | | | | | |
| coating amount (wt %) | 0.050(Al₂O₃) | | | 0.050(Al₂O₃) | | | 0.050(Al₂O₃) | | | 0.050(Al₂O₃) | | |
| inorganic additive | Pb₃O₄ | | | Pb₃O₄ | | | Bi₂O₃ | | | Bi₂O₃ | | |
| addition amount | 0.50 | | | 0.50 | | | 0.50 | | | 0.50 | | |
| coating thickness | thick | thick | thick | thin | thin | thin | thick | thick | thick | thin | thin | thin |
| Firing temperature | 800 | 850 | 900 | 800 | 850 | 900 | 800 | 850 | 900 | 800 | 850 | 900 |
| (° C.) | | | | | | | | | | | | |
| thickness of fired film | 14.2 | 14.3 | 13.6 | 7.5 | 7.5 | 7.3 | 13.9 | 14.1 | 14.0 | 7.6 | 7.7 | 7.2 |
| (μm) | | | | | | | | | | | | |
| sheet resistance | 2.2 | 2.1 | 1.9 | 2.1 | 1.9 | 1.9 | 2.2 | 2.1 | 2.1 | 2.1 | 2.1 | 1.9 |
| (mΩ/□) | | | | | | | | | | | | |
| solder wettability | ⊚ | ⊚ | ⊚ | ⊚ | ⊚ | ⊚ | ⊚ | ⊚ | ⊚ | ⊚ | ⊚ | ⊚ |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | ⊚ | ⊚ | ⊚ | ⊚ | ⊚ | ⊚ |
| 260° C. × 10 sec | ⊚ | ⊚ | ⊚ | ⊚ | ⊚ | ⊚ | ⊚ | ⊚ | ⊚ | ⊚ | ⊚ | ⊚ |
| 260° C. × 20 sec | ⊚ | ⊚ | ⊚ | ⊚ | ⊚ | ⊚ | ⊚ | ⊚ | ⊚ | ⊚ | ⊚ | ⊚ |
| Tensile strength (kg) | | | | | | | | | | | | |
| early stage | 3.47 | 4.29 | 4.45 | <1.0 | 3.34 | 3.47 | 3.29 | 3.79 | 3.66 | 2.65 | 2.63 | 3.96 |
| after 100 hour aging | 2.96 | 3.32 | 2.74 | 0.18 | 0.15 | 0.32 | 1.52 | 3.91 | 3.54 | <1.0 | <1.0 | 2.59 |
| after 200 hour aging | 2.74 | 3.17 | 3.36 | <0.1 | 0.1 | 0.19 | 1.91 | 3.61 | 3.55 | <0.1 | 0.34 | 0.95 |

TABLE 12

| | | | | | | | Comparative | | | Comparative | | |
|---|---|---|---|---|---|---|---|---|---|---|---|---|
| conductor paste | Example 22 | | | Example 22 | | | Example 2 | | | Example 2 | | |
| Ag average particle | 0.8˜1.0(0.8 >> 1.0) | | | 0.8˜1.0(0.8 >> 1.0) | | | about 1.0 | | | about 1.0 | | |
| size(μm) | | | | | | | | | | | | |
| coating amount | 0.050(Al₂O₃) | | | 0.050(Al₂O₃) | | | no coating | | | no coating | | |
| (wt %) | | | | | | | | | | | | |
| inorganic additive | Bi₂O₃ + lead glass | | | Bi₂O₃ + lead glass | | | Cu₂O + Bi₂O₃ | | | Cu₂O + Bi₂O₃ | | |
| addition amount | 0.50 + 0.25 | | | 0.50 + 0.25 | | | 0.50 + 0.50 | | | 0.50 + 0.50 | | |
| coating thickness | thick | thick | thick | thin | thin | thin | — | thick | — | — | thin | — |
| Firing temperature | 800 | 850 | 900 | 800 | 850 | 900 | — | 850 | — | — | 850 | — |
| (° C.) | | | | | | | | | | | | |
| thickness of fired | 13.6 | 13.2 | 12.8 | 7.2 | 6.9 | 6.9 | — | 12.8 | — | — | 7.0 | — |
| film (μm) | | | | | | | | | | | | |
| sheet resistance | 2.1 | 1.9 | 1.8 | 1.8 | 1.7 | 1.7 | — | 2.1 | — | — | 2.2 | — |
| (mΩ/□) | | | | | | | | | | | | |
| solder wettability | ⊚ | ⊚ | ⊚ | ⊚ | ⊚ | ⊚ | — | ⊚ | — | — | ⊚ | — |
| (230° C. × 3 sec) | | | | | | | | | | | | |
| resistance to | | | | | | | | | | | | |
| soldering heat | | | | | | | | | | | | |
| 230° C. × 30 sec | ⊚ | ⊚ | ⊚ | ⊚ | ⊚ | ⊚ | — | ◯ | — | — | X | — |
| 260° C. × 10 sec | ⊚ | ⊚ | ⊚ | ⊚ | ⊚ | ⊚ | — | X | — | — | X | — |
| 260° C. × 20 sec | ⊚ | ⊚ | ⊚ | ⊚ | ⊚ | ⊚ | — | X | — | — | X | — |
| Tensile strength (kg) | | | | | | | | | | | | |
| early stage | 3.31 | 4.05 | 3.36 | 3.84 | 3.86 | 4.34 | — | 4.13 | — | — | 4.1 | — |
| after 100 hour aging | 3.13 | 3.28 | 3.29 | 1.27 | 1.93 | 2.39 | — | 3.37 | — | — | 1.35 | — |
| after 200 hour aging | 2.93 | 2.67 | 0.3 | 0.17 | 0.485 | 0.76 | — | 1.68 | — | — | 0.92 | — |

As evident from the results shown in Tables 11 and 12, according to the paste conductors of these examples, a thin film conductor having a thickness of 10 μm or having the conductivity, solder wettability and resistance to soldering heat that are substantially equal to those of a comparatively thick film conductor can be formed. This indicates that according to the conductor pastes of the present invention, ceramic electronic components such as thin film circuit boards or thin film hybrid ICs having excellent electrical characteristics and/or mechanical characteristics can be produced preferably.

As evident from the above-described examples, conductor pastes that can meet one or two or more requirements of the following conditions are preferable.

(1) The metal powder is based on Ag powder having an average particle size of 0.2 to 1.0 μm.

(2) The metal powder is such that Ag particulates or particulates of an alloy based on Ag are coated with metal alkoxide (particularly preferably aluminum alkoxide, zirconium alkoxide).

(3) The coating amount (content rate) of the metal alkoxide is an amount corresponding to 0.01 to 0.1 wt % of the metal (Ag) powder in terms of oxide.

(4) One or two or more inorganic oxides (preferably copper oxide, lead oxide and/or bismuth oxide) are contained as inorganic additives in an amount corresponding to approximately 1 wt % or less of the metal (Ag) powder (preferably 0.5 wt % or less).

(5) One or two or more glass powders (preferably zinc glass, lead glass and/or borosilicate glass) are contained as inorganic additives in an amount corresponding to approximately 0.5 wt % or less of the metal (Ag) powder (preferably 0.25 wt % or less).

Furthermore, the above examples identified particularly preferable embodiments as a method for producing ceramic electronic components that is performed using the conductor paste of the present invention. A particularly preferable embodiment as the method for producing ceramic electronic components of the present invention can be a method characterized by using either one of the conductor pastes of the preferable examples described above, or a method characterized by firing the main component (i.e., coating metal powder) of the paste that is applied to the ceramic substrate at a temperature of 800 to 900° C. (maximum temperature).

### EXAMPLES 31 to 35

### Ag Paste for Side Film Conductor Formation

Five types of Ag pastes for side film conductor formation having compositions shown as examples 31 to 35 in Table 13 were prepared.

As the Ag based particulates, approximately spherical Ag powders having an average particle size of 0.3 to 0.5 μm (except Example 32) or 0.6 to 0.8 μm (only Example 32) that were prepared by a commonly used wet process were used. As the coating material, aluminum alkoxide (acetoalkoxy aluminum diisopropylate) was used in Examples 31 to 33, and zirconium alkoxide (zirconium butoxide) was used in Examples 34 and 35. Thus, the metal alkoxide was added to a suitable organic solvent (methanol in this example) and thus a coating solution having a concentration of 5 to 100 g/l was prepared. Then, the Ag powder was suspended in a suitable amount in the solution, and was kept suspended for 1 to 3 hours while being stirred as appropriate. Thereafter, the Ag powder was collected, and dried by ventilation at 60 to 110° C.

By the process described above, Ag powders (hereinafter, referred to as “coated Ag powder”) whose surfaces were coated substantially uniformly with aluminum alkoxide or zirconium alkoxide in an amount corresponding to about 0.0125 to 0.1 wt % (Examples 31 to 33), 0.025 to 0.5 wt % (Example 34) or 0.05 to 1 wt % (Example 35) of the total amount of the Ag powder in terms of the oxide (Al₂O₃ or ZrO₂) were obtained. The coating amount can be adjusted easily by adjusting the concentration of the metal alkoxide of the coating solution and, if necessary, the suspension time of the Ag powder, as appropriate.

For preparation of the Ag paste for side film conductor formation, a copper oxide (Cu₂O or CuO) powder having an average particle size of 1 to 5 μm and a specific surface area of 0.5 to 1.5 m²/g and a bismuth oxide (Bi₂O₃) powder having an average particle size of 1 to 10 μm and a specific surface area of 0.5 to 2.0 m²/g were used as the inorganic oxide powder.

Thus, the coated Ag powder having a final concentration (weight ratio) of 65 to 75 wt %, a bismuth oxide powder in an amount corresponding to 0.01 to 1.0 wt % (Examples 31 to 33) or 0.02 to 2.0 wt % (Examples 34 and 35) of the total amount of the coated Ag powder, a copper oxide powder in an amount corresponding to 0.005 to 0.5 wt % (Examples 31 to 33) or 0.01 to 1.0 wt % (Examples 34 and 35) of the total amount of the coated Ag powder, an organic binder (ethyl cellulose) in an amount corresponding to 1.5 to 10 wt % of the total amount of the coated Ag powder, and a solvent (a mixed solvent of BC (butyl carbitol), that is, diethylene glycol monobutyl ether and terpineol for Examples 31 and 32, and a mixed solvent of BC and ether (more specifically, trimethyl pentadiol monoisobutylate) for Examples 33 to 35) in the remaining amount were kneaded with a three-roll mill after the materials were weighed for the above amounts. Thus, five types of Ag pastes shown in Table 13 were obtained.

TABLE 13

| Ag paste for side | | | | | |
|---|---|---|---|---|---|
| film conductor | | | | | |
| formation | Example 31 | Example 32 | Example 33 | Example 34 | Example 35 |
| Ag average particle | 0.3˜0.5 | 0.6˜0.8 | 0.3˜0.5 | 0.3˜0.5 | 0.3˜0.5 |
| size(μm) | | | | | |
| Ag powder content | 65˜75 | 65˜75 | 65˜75 | 65˜75 | 65˜75 |
| ratio(%) | | | | | |
| coating substance | Al₂O₃ | Al₂O₃ | Al₂O₃ | ZrO₂ | ZrO₂ |
| (after firing) | | | | | |
| coating amount | 0.0125˜0.1 | 0.0125˜0.1 | 0.0125˜0.1 | 0.025˜0.5 | 0.05˜1 |
| (Ag ratio %) | | | | | |
| resin (organic | 1.5˜10 | 1.5˜10 | 1.5˜10 | 1.5˜10 | 1.5˜10 |
| binder: Ag ratio %) | | | | | |
| solvent | BC + terpineol | BC + terpineol | BC + ester | BC + ester | BC + ester |
| inorganic oxide | Bi₂O₃ | Bi₂O₃ | Bi₂O₃ | Bi₂O₃ | Bi₂O₃ |
| added and the | 0.01˜1.0 | 0.01˜1.0 | 0.01˜1.0 | 0.02˜2.0 | 0.02˜2.0 |
| amount(Ag ratio %) | Cu₂O | Cu₂O | Cu₂O | Cu₂O | Cu₂O |
| | 0.005˜0.5 | 0.005˜0.5 | 0.005˜0.5 | 0.01˜1.0 | 0.01˜1.0 |
| viscosity(Pa · s) | | | | | |
| 1T | 190 | 200 | 220 | 120 | 130 |
| 10T | 49.0 | 53.0 | 58.0 | 44.0 | 44.0 |
| 100T | 18.3 | 18.0 | 18.1 | 17.7 | 16.7 |
| viscosity ratio | | | | | |
| 1/10 | 3.88 | 3.77 | 3.79 | 2.73 | 2.95 |
| 1/100 | 10.38 | 11.11 | 12.15 | 6.78 | 7.78 |
| dry density(g/cm³) | 5.63 | 5.13 | 6.03 | 7.00 | 6.49 |
| shrinkage ratio | | | | | |
| (%) | | | | | |
| 700° C. | −18.1 | −17.3 | −16.9 | −16.3 | −13.5 |
| 900° C. | −16.5 | −20.8 | −12.9 | −14.8 | −14.6 |

### EXAMPLES 36 to 47

### Ag Paste for Surface Film Conductor Formation

Twelve types of Ag paste for surface film conductor formation having compositions shown as Examples 36 to 47 in Tables 14 to 16 were prepared. The same type of Ag powder and metal alkoxide as used in Examples 31 to 35 were used.

More specifically, a coating solution having a metal alkoxide concentration of 5 to 100 g/l was prepared, and the same process as producing the Ag paste for side film conductor formation was performed. Then, coated Ag powders whose surfaces were coated substantially uniformly with aluminum alkoxide or zirconium alkoxide in an amount corresponding to about 0.025 to 0.4 wt % of the Ag powder in terms of the oxide (Al₂O₃ or ZrO₂) were obtained.

Then, twelve types of Ag pastes were obtained by performing the same process as producing the Ag paste for side film conductor formation, using the coated Ag powder in an amount that provided a final paste concentration (weight ratio) of 83 to 86 wt % and the secondary components shown in Tables 14 to 16 (inorganic oxide, organic binder, solvent or the like) as appropriate. As seen from Tables 14 to 16, one feature of these Ag pastes for surface film conductor formation is that the content ratios of the Ag powder are higher than those of the Ag pastes for side film conductor formation of Table 13. Another feature is that inorganic oxide powder (bismuth oxide and copper oxide) is not contained in the Ag pastes of Examples 36 to 44. On the other hand, the Ag pastes of Examples 45 to 47 contain these inorganic oxide powders in a comparatively high ratio. The content ratio (ratio % with respect to Ag) of the organic binder (ethyl cellulose) and the type of the solvent used to produce each paste are shown in Tables 14 to 16. For preparation of the pastes of Examples 40 and 42, a trace amount of a dispersing agent (amine based agent in this example) was mixed.

TABLE 14

| Ag paste for surface | | | | | |
|---|---|---|---|---|---|
| film conductor | | | | | |
| formation | Example 36 | Example 37 | Example 38 | Example 39 | Example 40 |
| Ag average particle | 0.6˜0.8 | 0.8˜1.0 | 1.5˜2.0 | 0.6˜0.8 | 0.6˜0.8 |
| size (μm) | | | | | |
| Ag powder content | 85.0 | 85.6 | 85.0 | 83.4 | 84.8 |
| ratio (%) | | | | | |
| coating substance | Al₂O₃ | ZrO₂ | ZrO₂ | Al₂O₃ | Al₂O₃ |
| (after firing) | | | | | |
| coating amount (Ag | 0.1 | 0.025 | 0.025 | 0.2 | 0.4 |
| ratio %) | | | | | |
| resin (organic binder: | 1.8 | 1.8 | 1.8 | 1.8 | 1.8 |
| Ag ratio %) | | | | | |
| solvent | BC | BC | BC | BC | BC |
| inorganic oxide added | not added | not added | not added | not added | not added |
| and the amount (Ag | | | | | |
| ratio %) | | | | | |
| dispersant | not added | not added | not added | not added | 0.35 |
| (Ag ratio %) | | | | | |
| viscosity(Pa · s) | | | | | |
| 10T | 200 | 192 | 216 | 249.5 | 220.4 |
| 50T | 116 | 94.2 | 95.3 | 165.5 | 170 |
| 100T | 87 | 70 | 69.2 | 74.2 | 92.4 |
| dry density (g/cm³) | 5.89 | 6.26 | 5.74 | 5.51 | 5.04 |
| shrinkage ratio (%) | | | | | |
| 700° C. | −7.05 | −3.5 | 0 | −3.8 | −2.4 |
| 900° C. | −18.7 | −18.2 | −0.2 | −16 | −17.5 |

TABLE 15

| Ag paste for surface film conductor | | | | |
|---|---|---|---|---|
| formation | Example 41 | Example 42 | Example 43 | Example 44 |
| Ag average particle size (μm) | 0.3˜0.5 | 0.3˜0.5 | 0.6˜0.8 | 0.6˜0.8 |
| Ag powder content ratio (%) | 83.9 | 84.7 | 85.0 | 84.7 |
| coating substance (after firing) | Al₂O₃ | Al₂O₃ | Al₂O₃ | Al₂O₃ |
| coating amount (Ag ratio %) | 0.1 | 0.05 | 0.025 | 0.05 |
| resin (organic binder: Ag ratio %) | 1.8 | 1.8 | 1.8 | 1.8 |
| solvent | BC | BC | BC | BC |
| inorganic oxide added and the | not added | not added | not added | not added |
| amount (Ag ratio %) | | | | |
| dispersant (Ag ratio %) | not added | 0.2 | not added | not added |
| viscosity (Pa · s) | | | | |
| 10T | 278 | 231 | 235 | 221 |
| 50T | 96.9 | 110 | 127.6 | 124.8 |
| 100T | 64.3 | 74.5 | 90.7 | 91.2 |
| dry density (g/cm³) | 5.75 | 5.41 | 5.72 | 5.60 |
| shrinkage ratio (%) | | | | |
| 700° C. | −7.5 | −18.4 | −17.0 | −13.8 |
| 900° C. | −16.8 | −17.7 | −18.1 | −18.0 |

TABLE 16

| Ag paste for surface film | | | |
|---|---|---|---|
| conductor formation | Example 45 | Example 46 | Example 47 |
| Ag average particle size (μm) | 0.3˜0.5 | 0.3˜0.5 | 0.3˜0.5 |
| Ag powder content ratio (%) | 83.1 | 85.8 | 85.7 |
| coating substance (after firing) | ZrO₂ | Al₂O₃ | Al₂O₃ |
| coating amount (Ag ratio %) | 0.05 | 0.1 | 0.2 |
| resin (organic binder: | 2.3 | 2.3 | 2.3 |
| Ag ratio %) | | | |
| solvent | BC+ ester | BC+ ester | BC+ ester |
| inorganic oxide added and the | Bi₂O₃ 0.5 | Bi₂O₃ 1.0 | Bi₂O₃ 1.0 |
| amount (Ag ratio %) | Cu₂O 0.25 | Cu₂O 0.5 | Cu₂O 0.5 |
| dispersant (Ag ratio %) | not added | 0.3 | 0.6 |
| viscosity (Pa · s) | | | |
| 10T | 275 | 269 | 240 |
| 50T | 90 | 114 | 106 |
| 100T | 57.6 | 80.0 | 68.7 |
| dry density (g/cm³) | 5.95 | 5.51 | 5.30 |
| shrinkage ratio (%) | | | |
| 700° C. | −15.9 | −15.6 | −12.2 |
| 900° C. | −11.9 | −12.8 | −14.2 |

>Performance Evaluation of Ag Paste>

The viscosity (Pa·s) and the viscosity ratio of these Ag pastes were measured using a regular rotational viscometer (Model DV3 manufactured by Brook Field Co.) and a rotor (Model SC4-14 manufactured by Brook Field Co.). The results are shown in the corresponding fields in Tables 13 to 16. 1T, 10T, 50T and 100T indicate the viscosities at 1 rpm, 10 rpm, 50 rpm and 100 rpm, respectively.

As seen from Table 13, the Ag pastes for side film conductor formation have a low viscosity. In particular, the pastes containing a large amount of bismuth oxide (Examples 34 and 35) have a low viscosity. Therefore, with these Ag pastes for side film conductor formation, precise screen printing or the like can be performed well even with respect to a fine chip shaped ceramic base material.

On the other hand, as seen from Tables 14 to 16, the Ag pastes for surface film conductor formation have a higher viscosity that those of the Ag pastes for side film conductor formation, and suitable to be applied (printed) onto the surface of the base material or to fill through-holes. In addition, since the content ratio of the Ag powder is high, the conductivity resistance of the film conductor can be suppressed low.

The dry density (g/cm³) of the film conductor formed with each Ag paste was measured. More specifically, a film conductor was printed in a size of 30 mm×20 mm on an alumina substrate whose weight was previously measured. Then, a dry treatment was performed at 100 to 120° C. for about 10 minutes. Such a printing treatment and a drying treatment were repeated so that 3 to 5 printed films were laminated one after another. Then, the weight of this printed substrate was measured, and the weight of the alumina substrate was subtracted from the measurement value (weight of the printed substrate) so that the weight (the weight of the dry paste) of the printed layer was obtained. At the same time, the thickness of the printed layer was measured with a surface roughness meter or the like, and the volume of the printed layer was calculated based on the thickness. The dry density was derived from (the weight of the printed layer)/(the volume of the printed layer).

The obtained results are shown in the corresponding fields in Tables 13 to 16. All the Ag pastes can form a film conductor having a good dry density (i.e., film conductor having a low conductivity resistance).

The shrinkage ratio (%) when a film conductor was formed of each Ag paste was investigated. More specifically, each Ag paste was applied onto the surface of an alumina ceramic sheet having a thickness of about 1 mm according to commonly used screen printing (film thickness: 10 to 30 μm), and was subjected to a firing treatment at the maximum temperature of 950° C. The change in the shrinkage, that is, the degree of decrease in the volume (shrinkage volume percentage:-%) on the ceramic sheet at 700° C. and 900° C. when compared with that at room temperature (before firing) was investigated based on the thermomechanical analysis (TMA).

The obtained results are shown in the corresponding fields in Tables 13 to 16. All the Ag pastes exhibited a comparatively low shrinkage (0 to −21%). In particular, the shrinkage ratios of the Ag pastes of Examples 36 to 41 at 700° C. are within 0 to −10%. This indicates that in simultaneous firing with the ceramic base material, substantially no difference in the shrinkage ratio between the ceramic base material (alumina or the like) and the film conductor formed in its surface and/or its inner surface is generated. Therefore, by using these Ag pastes to form a surface film conductor or by using these Ag pastes to form an inner film conductor when producing a multilayer ceramic circuit board, an excessive difference in the shrinkage ratio between the film conductor and the ceramic base material at the time of simultaneous firing can be prevented from occurring, and as a result, a ceramic electronic component having excellent bond characteristics between the ceramic base material and the film conductor without significant structural defects can be produced.

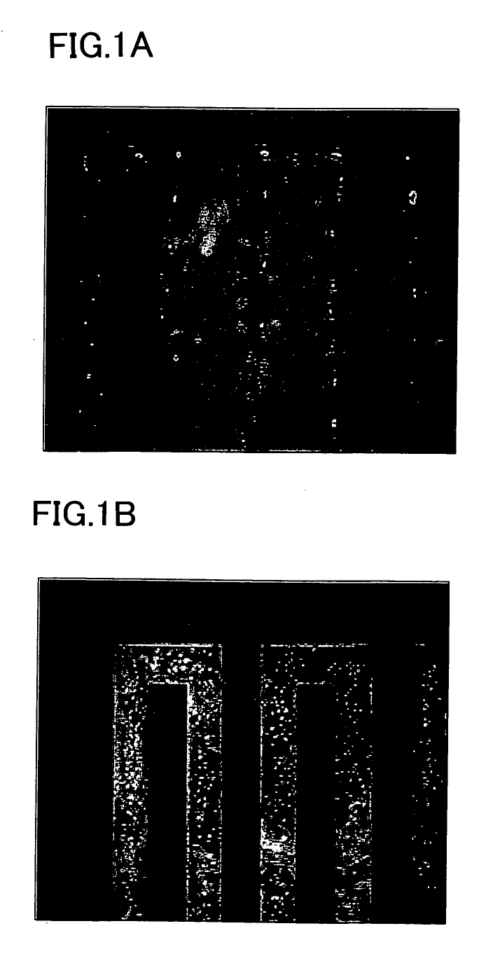

Furthermore, the heat resistance of these Ag pastes was investigated. More specifically, the Ag paste of Example 31 was applied onto an alumina ceramic substrate, and was subjected to a firing treatment at a temperature of 950° C. for one hour. For comparison, a ceramic substrate onto which a conventionally commonly used conductor paste having Ag powder alone whose surface is not coated with the organic metal compound or the metal oxide as the main component (hereinafter, referred to as “conventional Ag paste”) was applied was subjected to a firing treatment under the same conditions. FIGS. 1A and 1B show photographs of the surface of the ceramic substrate after such a firing treatment. As seen from these photographs, in the ceramic substrate onto which the conventional Ag paste was applied, peeling and evaporation of the film conductor were significant (see FIG. 1A). On the other hand, in the ceramic substrate onto which the Ag paste of the present invention was applied, no significant peeling, evaporation or foaming was not observed, and a good film conductor (sintered product) was formed and maintained (see FIG. 1B). This confirmed that the Ag paste of the present invention can be used for firing at a comparatively high temperature, although it is a conductor paste having Ag based particulates as the main component.

<Production of Ceramic Wiring Substrate>

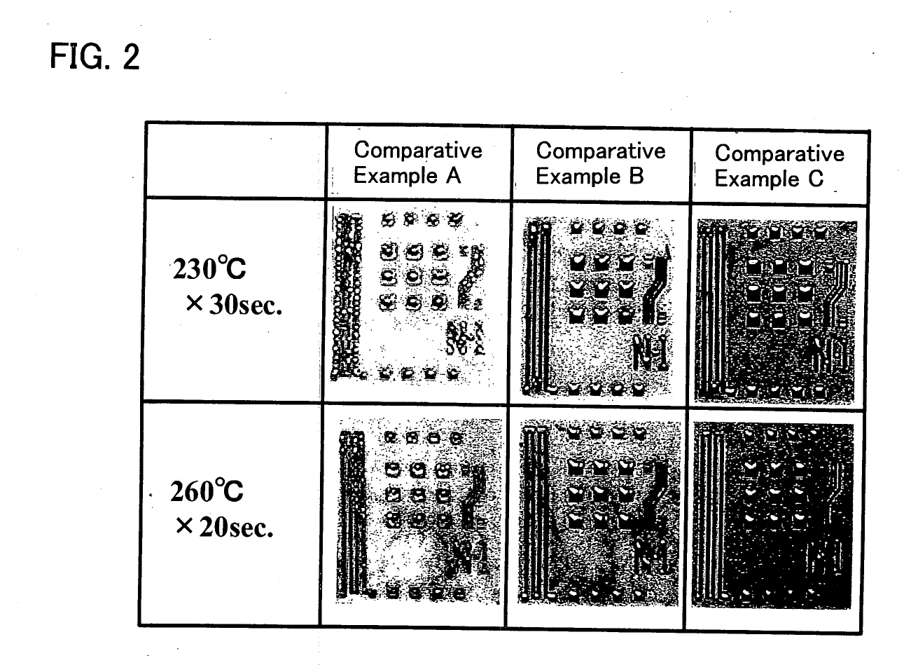

Next, a film conductor having a predetermined pattern (see FIG. 2) was formed on the surface of a ceramic base material (an alumina substrate having a thickness of about 2.0 mm in this example), using the Ag paste for surface film conductor formation. More specifically, the Ag paste of Example 31 was applied onto the surface of the ceramic substrate according to commonly used screen printing, and a coating film having a thickness of 10 to 30 μm was formed. Then, a drying treatment was performed with a dryer using far infrared radiation at 100° C. for 15 minutes. This drying treatment volatilized the solvent from the coating film, and thus an unfired film conductor was formed on the ceramic substrate.

Then, this film conductor together with the ceramic substrate were fired, specifically, in an electrical furnace at 700° C. for one hour. With this firing treatment, a ceramic wiring substrate on which the film conductor having the predetermined pattern was attached was obtained (see the photograph of the example of FIG. 2).

As a comparative example, the same treatment was performed, using a conventional Ag paste (Comparative Example A), a conventional conductor paste (Comparative Example B) containing an alloy powder of Ag and Pd in a ratio of 80/20 as the main component, and a conventional conductor paste containing an alloy powder of Ag and Pt in a ratio of 99.5/0.5 as the main component so as to produce ceramic wiring substrates on which film conductors having the same shape were attached.

The resistance to soldering heat was tested and measured in the following manner. A rosin flux was applied to a portion of the ceramic substrate on which a film conductor is to be formed, and then the substrate was immersed in a solder (Sn/Pb=60/40 (weight ratio)) having a predetermined temperature for a predetermined time. In this example, the soldering temperature and the immersing time were 230±5° C.×30 seconds, and 260±5° C.×20 seconds. FIG. 2 shows the photographs of the surface of the ceramic substrate after such immersion. As seen from the photographs of these surfaces, for the film conductor of Example 31, so-called “solder leaching” substantially did not occur under either conditions. For the film conductor of Comparative Example B formed of the Ag/Pd alloy, almost no solder leaching occurred. On the other hand, for the film conductor of Comparative Example A formed of the conventional Ag alone whose surface was not coated, significant solder leaching occurred, and 30% or more of the film conductor was lost compared with before immersion.

Thus, according to the present invention, although the film conductor is formed of a conductor paste containing Ag alone as the main component, the resistance to soldering heat equal to or more than that of the film conductor formed of an Ag/Pd alloy can be realized without performing a plating treatment such as Ni plating, solder plating or the like.

### TEST EXAMPLE 1

As Test Example 1 relevant to the present invention, the relationship between the coating amount of the organic metal salt and/or the firing temperature and the firing shrinkage ratio was examined.

More specifically, in the same manner as preparing the Ag pastes of the examples, six types of Ag paste (containing no inorganic oxide powder) in which Ag powder having an average particle size of 0.8 to 1.0 μm was dispersed in a solvent (BC) such that the content ratio thereof was 85 wt % and the coating amount of aluminum alkoxide was 0 to 0.5 wt % of the Ag powder in terms of the oxide (Al₂O₃) were prepared.

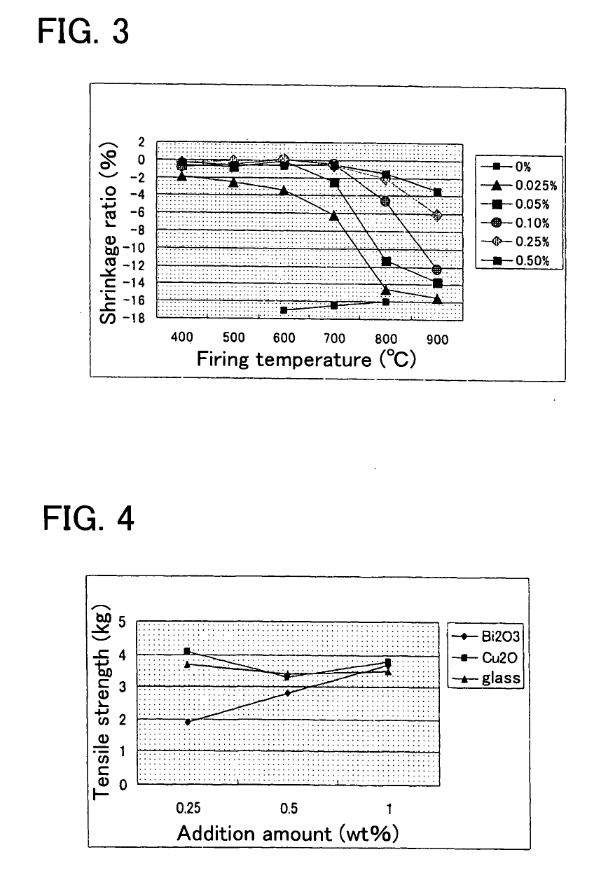

These pastes were applied to the surface of an alumina ceramic sheet in the same manner as described in the section <Performance evaluation of Ag paste>, a firing treatment was performed at 400 to 900° C. and the shrinkage ratio (%) was obtained. FIG. 3 shows the results. In the above-described range, as the coating amount increased, the shrinkage ratio decreased. It was confirmed that especially in those having a coating amount of 0.1% or more, a low shrinkage ratio was maintained, even if the firing treatment was performed at 800° C. or more (e.g., 900° C.).

### TEST EXAMPLE 2

As Test Example 2 relevant to the present invention, the relationship between the type and the addition amount of inorganic oxide powder and the bond strength (tensile strength) was examined.

More specifically, in the same manner as preparing the Ag pastes of the examples, Ag pastes in which Ag powder having an average particle size of 0.8 to 1.0 μm that was coated with aluminum alkoxide in an amount of 0.1 wt % of the Ag powder in terms of the oxide (Al₂O₃) was dispersed in a solvent (BC) such that the content ratio thereof was 85 wt % were prepared.

In this test example, nine Ag pastes containing bismuth oxide, copper oxide, or oxide glass (Bi₂O₃—B₂O₃—SiO₂ based glass) in an amount corresponding to 0.25 wt %, 0.5 wt % or 1 wt % of the total amount of the Ag powder were prepared.

Using these pastes, the same ceramic wiring substrate as above were produced, and subjected to the above-described tensile strength tests. FIG. 4 shows the results. As seen from the graph, it was confirmed that all the film conductors formed of the Ag pastes have high bond strength.

In the above, specific examples of the present invention have been described, but they are only illustrative and not limiting the scope of the claims. All changes and modifications from the specific examples illustrated above are intended to be embraced in the techniques disclosed in the appended claims.

The technical elements described in the specification or the drawings can exhibit technical usefulness, either alone or in combination, and combinations are not limited to those described in the claims as filed. The techniques illustrated in the specification or the drawings can achieve a plurality of purposes at the same time, and achieving only one of them has technical usefulness.

1-15. (Canceled)

16. A conductor composition comprising:
a metal powder substantially constituted by particulates of Ag or an Ag based alloy whose surfaces are coated with at least one organic metal compound having Al as a constituent metal element; and
an organic medium in which the metal powder is dispersed.

17. The conductor composition according to claim 16, wherein
the organic metal compound is an organic acid metal salt, metal alkoxide or a chelate compound having Al as a constituent metal element.

18. The conductor composition according to claim 16, wherein
a coating amount of the organic metal compound is an amount corresponding to 0.01 to 2.0 wt % of a total amount of the particulates in terms of oxide of a metal element constituting the compound.

19. The conductor composition according to claim 16, wherein
an average particle size of the particulates is 2.0 μm or less.

20. The conductor composition according to claim 16, comprising at least one oxide glass powder as an inorganic additive.

21. The conductor composition according to claim 20, wherein
a content of the glass powder is an amount corresponding to 0.5 wt % or less of a total amount of the metal powder.

22. The conductor composition according to claim 16, comprising at least one metal oxide powder selected from the group consisting of copper oxide, lead oxide, bismuth oxide, manganese oxide, cobalt oxide, magnesium oxide, tantalum oxide, niobium oxide and tungsten oxide as an inorganic additive.

23. The conductor composition according to claim 22, wherein
a content of the metal oxide powder is an amount corresponding to 1.0 wt % or less of a total amount of the metal powder.

24. A method for producing a paste-like or ink-like conductor composition having a metal powder as a main component, comprising:
preparing particulates of Ag or an Ag based alloy;
coating a surface of the particulates with at least one organic metal compound, the organic metal compound being an organic acid metal salt, metal alkoxide or a chelate compound having Al as a constituent metal element; and
dispersing the particulates coated with the organic metal compound in an organic medium.

25. The method according to claim 24, wherein
a coating amount of the organic metal compound is an amount corresponding to 0.01 to 2.0 wt % of a total amount of the particulates in terms of oxide of a metal element constituting the compound.

26. A method for producing a ceramic electronic component including a ceramic base material in which a film conductor is formed, comprising:
applying a paste-like or ink-like conductor composition obtained by dispersing particulates of Ag or an Ag based alloy whose surfaces are coated with at least one organic metal compound having Al as a constituent metal element in an organic medium to a ceramic base material; and
firing the applied conductor composition to form a film conductor on the ceramic base material.

27. The method according to claim 26, wherein
the conductor composition is applied to the ceramic base material such that a film conductor having a thickness of 10 μm or less is formed on the ceramic base material after the firing.

28. The method according to claim 26, wherein
a maximum temperature during firing is 800 to 900° C.
